(19) United States
(12) Patent Application Publication
(10) Pub. No.: US 2026/0182625 A1
(43) Pub. Date: Jul. 2, 2026

(54) AEROSOL-GENERATING ARTICLE WITH WRAPPER TO REDUCE CRYSTALLIZATION

(71) Applicant: Philip Morris Products S.A., Neuchatel (CH)

(72) Inventor: Farhang MOHSENI, Neuchâtel (CH)

(73) Assignee: Philip Morris Products S.A., Neuchatel (CH)

(21) Appl. No.: 19/128,653

(22) PCT Filed: Nov. 24, 2023
(86) PCT No.: PCT/EP2023/082934

§ 371 Date: May 9, 2025

(30) Foreign Application Priority Data
Nov. 25, 2022 (EP) 22209666.1

(51) Int. Cl. A24D 1/20; A24D 1/00; A24D 1/02; A24F 40/20; H05B 3/06

(52) U.S. Cl. CPC A24D 1/20; A24D 1/002; A24D 1/025; A24F 40/20; H05B 3/06

(57) ABSTRACT

An aerosol-generating article is provided, including: an aerosol-forming substrate having a pH value of below 5 and including an aerosol former content of at least 5 percent by weight on a dry weight basis; and a wrapper at least partly circumscribing the aerosol-forming substrate, the wrapper having a content of calcium carbonate of less than 45 percent by weight. An aerosol-generating system including the aerosol-generating article is also provided.

The present disclosure relates to an aerosol-generating article. The present disclosure further relates to an aerosol-generating system.

It is known to provide an aerosol-generating device for generating an inhalable vapor. Such devices may heat an aerosol-forming substrate contained in an aerosol-generating article without burning the aerosol-forming substrate. The aerosol-generating article may have a rod shape for insertion of the aerosol-generating article into a heating chamber of the aerosol-generating device.

The aerosol-generating device may comprise a heating arrangement. The heating arrangement may include one or more resistively heated heating elements. The heating arrangement may be an induction heating arrangement and may comprise an induction coil configured to inductively heat a susceptor. The susceptor may be part of the device or may be part of the aerosol-generating article.

Aerosol-generating articles in which the aerosol-generating substrate is provided in form of a gel or film with nicotine are known in the art. It is also known to include an acid in such substrates to advantageously enable the generation of an inhalable aerosol with improved sensory properties. Inclusion of an acid in such substrates may advantageously enable generation of an inhalable aerosol providing improved nicotine satisfaction to a user.

However, it has been observed that aerosol-generating substrates containing acids, for example organic acids such as lactic acid or fumaric acid, may tend to form deposits on an outer surface of a wrapper of the aerosol-generating article, particularly where the wrapper circumscribes the aerosol-forming substrate. It has been observed that such deposit formation may be particularly severe when the aerosol-generating articles are stored in one or both of warm environments and high humidity environments. Deposit formation on an outer surface of the wrapper may negatively affect the visual appearance of the article. Deposit formation on an outer surface of the wrapper may negatively affect the stability of the nicotine in the aerosol-forming substrate of the article. Deposit formation on an outer surface of the wrapper over time may negatively affect the shelf life of the article.

It would be desirable to provide an aerosol-generating article which reduces or prevents the formation of deposits on an outer surface of the aerosol-generating article, particularly when the aerosol-generating substrate within the aerosol generating article comprises acids.

According to an embodiment of the invention there is provided an aerosol-generating article. The aerosol-generating article may comprise an aerosol-forming substrate. The aerosol-forming substrate may have a pH value of below 5. The aerosol-forming substrate may comprise an aerosol former content of at least 5 percent by weight on a dry weight basis. The aerosol-generating article may comprise a wrapper at least partly circumscribing the aerosol-forming substrate. The wrapper may have a content of calcium carbonate of less than 45 percent by weight.

According to an embodiment of the invention there is provided an aerosol-generating article. The aerosol-generating article comprises an aerosol-forming substrate. The aerosol-forming substrate has a pH value of below 5. The aerosol-forming substrate comprises an aerosol former content of at least 5 percent by weight on a dry weight basis. The aerosol-generating article comprises a wrapper at least partly circumscribing the aerosol-forming substrate. The wrapper has a content of calcium carbonate of less than 45 percent by weight.

An aerosol-generating article is provided with reduced, or absence of, deposit formation on the outer wrapper circumscribing the aerosol generating substrate. An aerosol-generating article with reduced altering of the visual appearance over time may be provided. An aerosol-generating article with improved stability of the nicotine over time may be provided. An aerosol-generating article with a prolonged shelf life may be provided.

Without wishing to be bound by theory, it is believed that formation of deposits on the outer surface of the wrapper is caused by crystals which form when an acid from the aerosol-forming substrate comes into contact and reacts with a wrapping paper circumscribing the aerosol-forming substrate and comprising high amounts of filler materials, especially with calcium carbonate as the filler material. For example, the crystals may be made of calcium lactate when lactic acid is used in the aerosol-forming substrate. For example, the crystals may be made of calcium fumarate when fumaric acid is used in the aerosol-forming substrate.

As used herein, the term “filler material” generally relates to those materials known to the skilled person to be suitable for use a filler materials in the paper industry. Filler materials generally are water-insoluble, particulate substances, in the size range of about 0.1 to 10 μm, that are added to slurries of cellulosic fibers before the formation of paper. Typical filter materials may be China clay, calcium carbonate, talc, titanium dioxide, starch, calcium sulfate, Gypsum (calcium sulfate dihydrate), barium sulfate, magnesium carbonate, Bentonite, aluminium hydroxide (hydrated alumina), silicate minerals like silica or silicate pigments, and zinc pigments.

The wrapper may have a content of calcium carbonate of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight. The content of the calcium carbonate may be based on the total weight of the wrapper. The wrapper may comprise no calcium carbonate.

A sum of the content of calcium carbonate and magnesium carbonate in the wrapper may be less than 40 percent by weight, preferably less than 35 percent by weight, more preferably less than 30 percent by weight, more preferably less than 25 percent by weight, more preferably less than 20 percent by weight, more preferably less than 15 percent by weight, more preferably less than 10 percent by weight, more preferably less than 5 percent by weight, more preferably less than 4 percent by weight, more preferably less than 3 percent by weight, more preferably less than 2 percent by weight, more preferably less than 1 percent by weight. The sum of the content of calcium carbonate and magnesium carbonate may be based on the total weight of the wrapper. The wrapper may comprise no calcium carbonate and no magnesium carbonate.

The wrapper may have a content of alkaline metal carbonates of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight. The content of the alkaline metal carbonates may be based on the total weight of the wrapper. The wrapper may comprise no alkaline metal carbonates.

The wrapper may have a content of metal carbonates of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight. The content of the metal carbonates may be based on the total weight of the wrapper. The wrapper may comprise no metal carbonates.

The wrapper may have a total content of filler materials selected from one or more of China clay, calcium carbonate, talc, titanium dioxide, starch, calcium sulfate, Gypsum (calcium sulfate dihydrate), barium sulfate, magnesium carbonate, Bentonite, aluminium hydroxide (hydrated alumina), silicate minerals like silica or silicate pigments, and zinc pigments of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight. The wrapper may comprise no filler materials selected from China clay, calcium carbonate, talc, titanium dioxide, starch, calcium sulfate, Gypsum (calcium sulfate dihydrate), barium sulfate, magnesium carbonate, Bentonite, aluminium hydroxide (hydrated alumina), silicate minerals like silica or silicate pigments, and zinc pigments.

The wrapper may have a total content of filler materials of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight. The total content of filler materials may be based on the total weight of the wrapper. The wrapper may comprise no filler materials.

A ratio of weight percentages of calcium carbonate to other fillers comprised in the wrapper may be between 0 and 10, preferable between 0 and 1, more preferably between 0 and 0.5, more preferably between 0 and 0.3, more preferably between 0 and 0.2, more preferably between 0 and 0.1.

A ratio of calcium carbonate to titanium dioxide comprised in the wrapper may be between 0 and 10, preferable between 0 and 1, more preferably between 0 and 0.5, more preferably between 0 and 0.3, more preferably between 0 and 0.2, more preferably between 0 and 0.1.

The wrapper may comprise one or more fillers other than calcium carbonate, and the sum of the weight percentage of the one or more fillers other than calcium carbonate in the wrapper may be at least equal to the weight percentage of calcium carbonate in the wrapper.

The wrapper may comprise titanium dioxide, and the weight percentage of titanium dioxide in the wrapper may be at least equal to the weight percentage of calcium carbonate in the wrapper.

The wrapper may comprise both titanium dioxide and calcium carbonate. The wrapper may comprise titanium dioxide and may be free of calcium carbonate.

The wrapper may comprise at least 5 percent by weight, preferably at least 10 percent by weight, more preferably at least 15 percent by weight, more preferably at least 20 percent by weight, more preferably at least 25 percent by weight, more preferably at least 30 percent by weight, more preferably at least 35 percent by weight, more preferably at least 40 percent by weight of titanium dioxide. The content of titanium dioxide may be based on the total weight of the wrapper.

The wrapper may comprise at least 70 percent by weight, preferably at least 75 percent by weight, more preferably at least 80 percent by weight, more preferably at least 85 percent by weight, more preferably at least 90 percent by weight, more preferably at least 95 percent by weight, more preferably at least 97 percent by weight, more preferably at least 98 percent by weight, more preferably at least 99 percent by weight, more preferably at least 99.5 percent by weight of cellulose fibers.

The wrapper may comprise, on a dry weight basis, at least 70 percent by weight, preferably at least 75 percent by weight, more preferably at least 80 percent by weight, more preferably at least 85 percent by weight, more preferably at least 90 percent by weight, more preferably at least 95 percent by weight, more preferably at least 97 percent by weight, more preferably at least 98 percent by weight, more preferably at least 99 percent by weight, more preferably at least 99.5 percent by weight of cellulose fibers. The content of cellulose fibers may be based on the total weight of the wrapper.

The wrapper at least partly circumscribing the aerosol-forming substrate and having a content of calcium carbonate of less than 45 percent by weight may be a tipping wrapper circumscribing several components of the article including the portion comprising the aerosol-forming substrate. The tipping wrapper, or at least a portion thereof, may form the outermost layer of the aerosol-generating article.

The wrapper at least partly circumscribing the aerosol-forming substrate and having a content of calcium carbonate of less than 45 percent by weight may be a single component wrapper circumscribing only the aerosol-forming substrate.

The grammage of the wrapper may be between 30 grams per square meter and 100 grams per square meter, preferably between 50 grams per square meter and 90 grams per square meter, more preferably between 60 grams per square meter and 80 grams per square meter.

The thickness of the wrapper may be between 50 micrometers and 90 micrometers, preferably between 60 micrometers and 80 micrometers, more preferably between 65 micrometers and 75 micrometers.

The grammage of the wrapper may be between 55 grams per square meter and 65 grams per square meter and the thickness of the wrapper may be between 65 micrometers and 75 micrometers and, optionally, the wrapper may be free of any filler.

The wrapper may exhibit a permeability of the wrapper of less than 100 CORESTA units, less than 80 CORESTA units, less than 50 CORESTA units, less than 40 CORESTA units, or less than 30 CORESTA units. The wrapper may exhibit a permeability of the wrapper of less than 20 CORESTA units, less than 10 CORESTA units, less than 8 CORESTA units, less than 6 CORESTA units, or less than 5 CORESTA units. The wrapper may exhibit a permeability of the wrapper of between 1 and 10 CORESTA units, preferably between 1 and 5 CORESTA units, more preferably between 2 and 4 CORESTA units, more preferably of about 3 CORESTA units.

The permeability of the wrapper may be determined by utilizing the International Standard test method ISO 2965:2009 and the result may be presented as cubic centimeters per minute per square centimeters and referred to as “CORESTA units”.

The wrapper may be embossed or may not be embossed. The wrapper may be both perforated and embossed.

The term “embossment” is used herein to refer to protrusions formed in the surface of a wrapper. These protrusions may be carved, moulded or stamped into the wrapper. The portion of wrapper carrying such embossments is said to be embossed.

The wrapper may comprise an embossed portion. The embossed portion of the wrapper may have one embossment. The embossed portion of the wrapper may have a plurality of embossments. The one or more embossments may have a depth of from 0.07 millimeter to 0.21 millimeter, preferably from 0.10 millimeter to 0.18 millimeter and more preferably from 0.12 millimeter to 0.16 millimeter. Each embossment may also have a pitch of from 0.2 millimeter to 0.4 millimeter, preferably from 0.25 millimeter to 0.35 millimeter, more preferably from 0.275 millimeter to 0.325 millimeter.

The wrapper may have a roughness of between about 50 Bekk seconds and about 1000 Bekk seconds, preferably between about 100 Bekk seconds and about 200 Bekk seconds. The roughness expressed in Bekk seconds may be measured by means of a standard test using a BEKK Smoothness Tester, which creates a vacuum and measures the time it takes for the vacuum to drop from 50.66 kPa to 48.00 kPa. The test is recognized by the international standard ISO 5627.

The thickness of the wrapper may be determined in accordance to ISO 534:2011. The thickness of the wrapper may be determined in accordance to ASTM E252-06 (2021) e1. Generally, for embossed wrappers, the local thickness at a position of an embossment may be less than the thickness at a position without an embossment. As used herein, for embossed wrappers, the thickness of the wrapper refers to the thickness at positions without embossments. For embossed wrappers, the thickness of the wrapper may be determined before the wrapper is being embossed.

Unless defined otherwise, all measurements described herein are performed after conditioning the samples in accordance to ISO Standard 3402:1999.

The wrapper may be in direct physical contact with the aerosol-forming substrate. In that case, there is no layer of material between the wrapper and the aerosol-forming substrate.

The wrapper may comprise one or more of cardboard, plastics, and metal foil.

The wrapper may comprise a cellulosic material, for example one or more of paper, wood, textile, natural fibers, and artificial fibers. The wrapper may comprise a paper layer. The wrapper may be made of a cellulosic material, for example one or more of paper, wood, textile, natural fibers, and artificial fibers. The wrapper may a paper wrapper. The wrapper may be made of paper. The wrapper may be made of a paper layer. The wrapper may be made of a single paper sheet.

The wrapper may comprise a laminate sheet. The wrapper may be made of a single laminate sheet. The laminate sheet may be a laminate of a paper layer with an aluminum layer.

The wrapper may be formed of a laminate material comprising a plurality of layers. The wrapper may be formed of a metallic co-laminated sheet, for example an aluminium co-laminated sheet. The metallic layer of the co-laminated sheet may have a grammage from 12 grams per square meter to 25 grams per square meter, preferably from 15 grams per square meter to 20 grams per square meter. The metallic layer of the co-laminated sheet may have a thickness from 2 micrometers to 15 micrometers, preferably from 3 micrometers to 12 micrometers, more preferably from 5 micrometers to 10 micrometers.

The wrapper may be a paper wrapper comprising PVOH (polyvinyl alcohol) or silicone (or polysiloxane) (or polysiloxane). Addition of PVOH (polyvinyl alcohol) or silicone (or polysiloxane) may improve the grease barrier properties of the wrapper.

The wrapper may comprise a flame retardant composition comprising one or more flame retardant compounds. The term “flame retardant compounds” is used herein to describe chemical compounds that, when added to or otherwise incorporated into a carrier substrate, such as paper or plastic compounds, provide the carrier substrate with varying degrees of flammability protection.

A number of suitable flame retardant compounds are known to the skilled person. In particular, several flame retardant compounds and formulations suitable for treating cellulosic materials are known and have been disclosed and may find use in the manufacture of wrappers for aerosol-generating articles in accordance with the present invention.

In particularly preferred embodiments, in addition to the wrapper at least partly circumscribing the aerosol-forming substrate and having a content of calcium carbonate of less than 45 percent by weight described herein, one or more of the components of the aerosol-generating article may be individually circumscribed by their own single component wrapper.

Preferably, at least one of the components of the aerosol-generating article is wrapped in a hydrophobic wrapper.

The term “hydrophobic” refers to a surface exhibiting water repelling properties. One useful way to determine this is to measure the water contact angle. The “water contact angle” is the angle, conventionally measured through the liquid, where a liquid/vapour interface meets a solid surface. It quantifies the wettability of a solid surface by a liquid via the Young equation. Hydrophobicity or water contact angle may be determined by utilizing TAPPI T558 test method and the result is presented as an interfacial contact angle and reported in “degrees” and can range from near zero to near 180 degrees.

In preferred embodiments, the hydrophobic wrapper is one including a paper layer having a water contact angle of about 30 degrees or greater, and preferably about 35 degrees or greater, or about 40 degrees or greater, or about 45 degrees or greater.

By way of example, the paper layer may comprise PVOH (polyvinyl alcohol) or silicone. The PVOH may be applied to the paper layer as a surface coating, or the paper layer may comprise a surface treatment comprising PVOH or silicone.

The wrapper at least partly circumscribing the aerosol-forming substrate and having a content of calcium carbonate of less than 45 percent by weight may comprise an alkaline paper having a pH value of above 7. The wrapper may have a pH value of more than 8. The wrapper may have a pH value of below 7.8. The wrapper may have a pH value of above 7 and below 7.8.

The aerosol-forming substrate may have a pH value of between 3.5 and 4.9, preferably between 3.6 and 4.9, more preferably between 3.7 and 4.9, more preferably between 3.8 and 4.9.

The pH value of the wrapper may be measured by ISO protocol ISO 6588-1. Preferably, the pH value of the wrapper is measured by Test Method A as described herein. The pH value of the aerosol-forming substrate may be measured by Test Method B as described herein.

### Test Method A—Measuring the pH Value of the Wrapper:

Step 1: Cut the sample with a knife or cutter, or tear it, into pieces of approximately 1 square centimeter in size.

Step 2: Weigh in a 250 milliliters flask 2.5 grams±0.1 grams of the sample which has been conditioned for 40 hours at 22.5 degrees Celsius+/−2.5 degrees Celsius in air at 50 percent+/−5 percent relative humidity.

Step 3: Add 22.5 grams of deionized water.

Step 4: Check that all pieces are soaked. Seal the flask with its ground-glass stopper and leave it to stand for 10 hours at a temperature between at 22.5 degrees Celsius+/−2.5 degrees Celsius. Shake the flask at least once during this time.

Step 5: Filter the extract through a coarse, fritted glass filter into a small beaker.

Step 6: Measure the pH value with a pH meter which is fitted with glass and calomel electrodes or with a combined electrode and which is capable of being read to at least 0.05 pH unit. Operate the pH meter in accordance with the manufacturer's instruction. After calibration of the pH meter, rinse the electrodes several times with deionized water and once in a small quantity of the extract. Check that the temperature of the extract is between at 22.5 degrees Celsius+/−2.5 degrees Celsius. Immerse the electrodes in the extract. Record the pH value when there is no measurable drift, within 30 seconds.

Before measuring a next sample, rinse the electrodes carefully with deionized water to remove any traces of sample or buffer solution. At the end of a series of measurements, check the electrodes with the same buffer solutions. The results for both solutions should agree with their correct value to within 0.1 pH unit. Otherwise repeat the procedure.

Step 7: Measure the pH value in accordance to step 6 twice and calculate the mean of the duplicate determinations. The individual results should not differ by more than 0.2 pH unit. Otherwise, repeat the determination with two additional extracts, and report the mean and the range of all measurements.

### Test Method B—Measuring the pH Value of the Aerosol-Forming Substrate:

Step 1: In case the aerosol-forming substrate is provided in form of a sheet-like structure, cut the sample with a knife or cutter, or tear it, into pieces approximately 1 square centimeter in size. In case the aerosol-forming substrate is provided as loose material proceed with the loose sample as is.

Proceed with steps 2 and 3 as defined in Test Method A.

Step 4: Shred the material with a disperser (for example an “IKA T 18” device). Seal the flask with its ground-glass stopper and leave it to stand for 10 hours at a temperature between at 22.5 degrees Celsius+/−2.5 degrees Celsius. Shake the flask at least once during this time.

Proceed with steps 5 to 7 as defined in Test Method A.

As used herein, the term “aerosol-forming substrate” refers to a substrate capable of releasing volatile compounds that can form an aerosol. Such volatile compounds may be released by heating the aerosol-forming substrate. The aerosol-forming substrate may be in solid form or may be in liquid form. The aerosol-forming substrate may be solid or liquid or may comprise both solid and liquid components. An aerosol-forming substrate may be part of an aerosol-generating article. The terms ‘aerosol’ and ‘vapor’ are used synonymously.

The aerosol-forming substrate may comprise one or more of: tobacco, nicotine, an aerosol-forming film, a gel composition, and a flavour agent.

The aerosol-forming substrate may comprise a total aerosol former content on a dry weight basis of at least 10 percent by weight, preferably at least 15 percent by weight, more preferably at least 20 percent by weight, more preferably at least 25 percent by weight, more preferably at least 30 percent by weight, more preferably at least 35 percent by weight, more preferably at least 40 percent by weight, more preferably at least 45 percent by weight, more preferably at least 50 percent by weight, more preferably at least 55 percent by weight.

The aerosol-forming substrate may comprise at least 35 percent by weight of one or more aerosol formers. The aerosol-forming substrate may comprise at least 35 percent by weight of one or more aerosol formers on a dry weight basis of the aerosol-forming substrate. Unless defined otherwise, all percentages by weight described herein are on a dry weight basis. The content of aerosol former may be based on the total dry weight of the aerosol-forming substrate.

The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof. Preferably, the one or more aerosol formers comprise one or both of glycerol and propylene glycol. The one or more aerosol formers may consist of one or both of glycerol and propylene glycol. Preferably, the aerosol-forming substrate comprises glycerol. The terms “glycerine” and “glycerol” are used synonymously herein.

The aerosol-forming substrate may comprise less than or equal to 80 percent by weight of aerosol former on a dry weight basis of the aerosol-forming substrate. The aerosol-forming substrate may comprise less than or equal to 60 percent by weight of aerosol former on a dry weight basis of the aerosol-forming substrate. The aerosol-forming substrate may comprise less than or equal to 40 percent by weight of aerosol former on a dry weight basis of the aerosol-forming substrate.

The aerosol-forming substrate may comprise between 35 percent and 80 percent, or between 35 percent and 60 percent, or between 35 percent and 55 percent, or between 35 percent and 50 percent, or between 35 percent and 40 percent by weight of aerosol former on a dry weight basis of the aerosol-forming substrate.

The total aerosol former content of the aerosol-forming substrate may be at least 40 percent by weight, preferably at least 45 percent by weight, more preferably at least 50 percent by weight, more preferably at least 55 percent by weight. The total aerosol former content of the aerosol-forming substrate may be between 35 percent by weight and 75 percent by weight, preferably between 40 percent by weight and 60 percent by weight, more between 45 percent by weight and 55 percent by weight.

The aerosol-forming substrate may comprise nicotine. The aerosol-forming substrate may comprise one or more carboxylic acids. The aerosol-forming substrate may comprise nicotine, one or more cellulose based agents, one or more aerosol formers, and one or more carboxylic acids.

The one or more carboxylic acids may be selected from fumaric acid, maleic acid, and malic acid. The one or more carboxylic acids may be selected from fumaric acid and maleic acid. The one or more carboxylic acids may be fumaric acid. The one or more carboxylic acids may have a pKa at 25° C. in water of less than or equal to 3.5. The aerosol-forming substrate may comprise one or more carboxylic acids selected from acetic acid, benzoic acid, lactic acid, and levulinic acid.

The aerosol-forming substrate may comprise between 0.1 percent by weight and 8 percent by weight, preferably between 0.5 percent by weight and 6 percent by weight, more preferably between 0.5 percent by weight and 5 percent by weight, more preferably between 0.5 percent by weight and 4 percent by weight, more preferably between 1.5 percent by weight and 4 percent by weight, more preferably between 2 percent by weight and 4 percent by weight of one or more carboxylic acids on a dry weight basis. The content of carboxylic acids may be based on the total dry weight of the aerosol-forming substrate.

The aerosol-forming substrate may comprise one or more carboxylic acids that do not contain any non-carboxyl hydroxyl groups.

In one preferred embodiment of the invention, the aerosol-forming substrate comprises fumaric acid and the wrapper may not comprise any filler material.

The aerosol-forming substrate may comprise nicotine and one or more carboxylic acids, and a molar ratio of total carboxylic acid to nicotine may be between 0.5:1 and 5:1, preferable between 1:1 and 4:1, more preferably between 2:1 and 3.5:1, more preferably between 0 and 0.3, more preferably between 0 and 0.2, more preferably between 0 and 0.1.

The aerosol-forming substrate may comprise between 0.5 percent by weight and 5 percent by weight, preferably between 0.5 percent by weight and 3 percent by weight, more preferably between 1 percent by weight and 2 percent by weight of fumaric acid on a dry weight basis.

The aerosol-forming substrate may comprise between 0.5 percent by weight and 5 percent by weight, preferably between 0.5 percent by weight and 3 percent by weight, more preferably between 1 percent by weight and 2 percent by weight of maleic acid on a dry weight basis.

The aerosol-forming substrate may comprise one or both of fumaric acid and maleic acid, and the sum of fumaric acid and maleic acid comprised in the aerosol-forming substrate may be between 0.5 percent by weight and 5 percent by weight, preferably between 0.5 percent by weight and 3 percent by weight, more preferably between 1 percent by weight and 2 percent by weight on a dry weight basis.

The aerosol-forming substrate may comprise less than 6 percent by weight, preferably less that 4 percent by weight, more preferably less than 2 percent by weight, more preferably less than 1 percent by weight of malic acid on a dry weight basis.

The aerosol-forming substrate may have a total cellulose based agent content of between 35 percent by weight and 50 percent by weight. The aerosol-forming substrate may comprise one or more cellulose based film-forming agents selected from carboxymethyl cellulose and hydroxypropyl methylcellulose. The aerosol-forming substrate may comprise one or more cellulose based strengthening agents selected from cellulose fibres, microcrystalline cellulose and cellulose powder. The total cellulose based agent content may be based on the total dry weight of the aerosol-forming substrate.

The aerosol-forming substrate may be an aerosol-forming film. The aerosol-forming substrate may be a solid aerosol-forming film. The solid aerosol-forming film may be solid at room temperature. The solid aerosol-forming film may remain solid when heated to a temperature of between 180 degrees Celsius and 350 degrees Celsius.

The aerosol-forming substrate may be provided in form of a gel.

The aerosol-forming substrate may comprise a tobacco content on a dry weight basis of less than 75 percent by weight, preferably less than 70 percent by weight, more preferably less than 65 percent by weight, more preferably less than 60 percent by weight, more preferably less than 55 percent by weight, more preferably less than 50 percent by weight, more preferably less than 45 percent by weight, more preferably less than 40 percent by weight, more preferably less than 35 percent by weight, more preferably less than 30 percent by weight, more preferably less than 25 percent by weight, more preferably less than 20 percent by weight, more preferably less than 15 percent by weight, more preferably less than percent by weight, more preferably less than 5 percent by weight, more preferably less than 4 percent by weight, more preferably less than 3 percent by weight, more preferably less than 2 percent by weight, more preferably less than 1 percent by weight. The tobacco content may be based on the total dry weight of the aerosol-forming substrate.

The aerosol-forming substrate may be substantially tobacco-free. The aerosol-forming substrate may be tobacco-free.

The aerosol-forming substrate may comprise one or more carboxylic acids and the aerosol-forming substrate may have a total carboxylic acid content of greater than or equal to 0.5 percent by weight. The aerosol-forming substrate may not comprise iota-carrageenan or kappa-carrageenan.

The aerosol-forming substrate may be a solid aerosol-forming substrate. As used herein with reference to the invention, the term “solid” is used to describe an aerosol-forming substrate that has a stable size and shape and does not flow at room temperature-room temperature is about 23 degrees Celsius.

For example, the aerosol-forming substrate may remain solid when heated to a temperature of between 180 degrees Celsius and 350 degrees Celsius, between 200 degrees Celsius and 320 degrees Celsius, between 220 degrees Celsius and 300 degrees Celsius, or between 240 degrees Celsius and 280 degrees Celsius.

The aerosol-forming substrate may be an aerosol-forming film.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The solid aerosol-forming substrate may be a solid aerosol-forming film.

The aerosol-forming film comprises one or more aerosol formers as described herein, preferably the aerosol-former comprises glycerine, or is glycerine. The aerosol-forming film may have an aerosol former content of at least 35 percent by weight on a dry weight basis. Preferably, the aerosol-forming film has an aerosol former content of at least 40 percent by weight on a dry weight basis. More preferably, the aerosol-forming film has an aerosol former content of at least 45 percent by weight on a dry weight basis. More preferably, the aerosol-forming film has an aerosol former content of at least 50 percent by weight on a dry weight basis.

Preferably, the aerosol-forming film has an aerosol former content of no more than 80 percent by weight on a dry weight basis. More preferably, aerosol-forming film has an aerosol former content of no more than 75 percent by weight on a dry weight basis. More preferably, the aerosol-forming film has an aerosol former content of no more than 70 percent by weight on a dry weight basis.

The aerosol-forming substrate may be in the form of an aerosol-forming film comprising a cellulosic based film forming agent, nicotine and an aerosol former. The aerosol-forming film may further comprise a cellulose based strengthening agent. The aerosol-forming film may further comprise water, preferably 30 percent by weight of less of water.

As used herein with reference to the invention, the term “thickness” is used to describe the minimum dimension between opposite, substantially parallel surfaces of a solid aerosol-forming film.

The solid aerosol-forming film may have a thickness of greater than or equal to 0.05 millimeters, greater than or equal to 0.1 millimeters, greater than or equal to 0.2 millimeters, or greater than or equal to 0.3 millimeters. The solid aerosol-forming film may have a thickness of less than or equal to 1.2 millimeters, less than or equal to 1 millimeter, less than or equal to 0.8 millimeters, less than or equal to 0.6 millimeters, or less than or equal to 0.4 millimeters.

The solid aerosol-forming film may have a basis weight of greater than or equal to 85 grams per square meter, greater than or equal to 100 grams per square meter, greater than or equal to 120 grams per square meter, or greater than or equal to 140 grams per square meter. The solid aerosol-forming film may have a basis weight of less than or equal to 300 grams per square meter, less than or equal to 280 grams per square meter, or less than or equal to 260 grams per square meter.

The solid aerosol-forming film may be formed by any suitable method. For example, the solid aerosol-forming film may be formed by batch casting, continuous casting or extrusion.

The solid aerosol-forming film may be self-supporting. In other words, the properties of the solid aerosol-forming film may be such that, even if the solid aerosol-forming film is formed by casting a slurry onto a support surface, the solid aerosol-forming film can be separated from the support surface.

The solid aerosol-forming film may be disposed on a support or the solid aerosol-forming film may be sandwiched between other materials. This may enhance the mechanical stability of the solid aerosol-forming film. For example, the solid aerosol-forming film may be disposed on a laminar support.

The solid aerosol-forming film may be cut or otherwise divided into a plurality of strips or shreds that may be wrapped to form the aerosol-forming portion wrapped by the wrapper.

The solid aerosol-forming film may be gathered before insertion into the aerosol-forming portion. The solid aerosol-forming film may be textured. This may facilitate gathering of the solid aerosol-forming film before insertion into the aerosol-forming portion.

As used herein with reference to the invention, the term “textured” is used to describe a solid aerosol-forming film that has been crimped, embossed, debossed, perforated or otherwise deformed. Textured solid aerosol-forming film may comprise a plurality of spaced-apart indentations, protrusions, perforations or a combination thereof.

The solid aerosol-forming film may be crimped.

As used herein with reference to the invention, the term “crimped” is intended to be synonymous with the term “creped” and is used to describe a solid aerosol-forming film having a plurality of substantially parallel ridges or corrugations.

The solid aerosol-forming film may be incorporated directly into the aerosol-forming portion.

The solid aerosol-forming film may be applied to a laminar support before being incorporated into the aerosol-forming portion. For example, the solid aerosol-forming film may be applied to the surface of a sheet material. Suitable sheet materials for use as the laminar support include, but are not limited, to: paper; cardboard; and homogenised plant material. For example, the solid aerosol-forming film may be applied to a paper sheet, an aluminium coated paper sheet, or a polyethylene coated paper sheet.

The laminar support with the solid aerosol-forming film applied thereto may be cut or otherwise divided into a plurality of strips or shreds as described above.

The laminar support with the solid aerosol-forming film applied thereto may be gathered as described above.

The laminar support with the solid aerosol-forming film applied thereto may be textured as described above.

As used herein with reference to the invention, the term “aerosol former” is used to describe a compound that, in use, facilitates formation of the aerosol, and that preferably is substantially resistant to thermal degradation at the operating temperature of an aerosol-generating article or aerosol-generating system comprising the solid aerosol-forming substrate.

Examples of suitable aerosol formers include: polyhydric alcohols, such as 1,3-butanediol, glycerine, 1,3-propanediol, propylene glycol, and triethylene glycol; esters of polyhydric alcohols, such as glycerol mono-, di- or triacetate; and aliphatic esters of mono-, di- or polycarboxylic acids, such as dimethyl dodecanedioate and dimethyl tetradecanedioate.

The aerosol-forming substrate may have a total aerosol former content of greater than or equal to 35 percent by weight. The aerosol-forming substrate may have a total aerosol former content of greater than or equal to 40 percent by weight, or greater than or equal to 45 percent by weight, or greater than or equal to 50 percent by weight.

As used herein with reference to the invention, the term “total aerosol former content” is used to describe the combined content of all aerosol formers in the aerosol-forming substrate.

The solid aerosol-forming substrate may have a total aerosol former content of greater than or equal to 46 percent by weight, greater than or equal to 48 percent by weight, greater than or equal to 50 percent by weight, or greater than or equal to 52 percent by weight.

The solid aerosol-forming substrate may have a total aerosol former content of less than or equal to 62 percent by weight, less than or equal to 60 percent by weight, less than or equal to 58 percent by weight, less than or equal to 56 percent by weight, or less than or equal to 54 percent by weight.

The solid aerosol-forming substrate may have a total aerosol former content of between 42 percent by weight and 62 percent by weight, between 46 percent by weight and 60 percent by weight, between 46 percent by weight and 58 percent by weight, between 46 percent by weight and 56 percent by weight, or between 46 percent by weight and 54 percent by weight.

Preferably, the solid aerosol-forming substrate comprises one or more polyhydric alcohols.

The solid aerosol-forming substrate may have a total polyhydric alcohol content of greater than or equal to 45 percent by weight, greater than or equal to 46 percent by weight, greater than or equal to 48 percent by weight, greater than or equal to 50 percent by weight, or greater than or equal to 52 percent by weight.

Preferably, the solid aerosol-forming substrate comprises one or more polyhydric alcohols selected from 1,3-butanediol, glycerine, 1,3-propanediol, propylene glycol, and triethylene glycol.

More preferably, the solid aerosol-forming substrate comprises one or more polyhydric alcohols selected from glycerine and propylene glycol. Most preferably, the solid aerosol-forming substrate comprises glycerine.

The solid aerosol-forming substrate may comprise one or more carboxylic acids having a pKa at 25° C. in water of less than or equal to 3.5.

As used herein with reference to the invention, the term “carboxylic acids having a pKa at 25° C. in water of less than or equal to 3.5” is used to describe monoprotic carboxylic acids having a pKa at 25° C. in water of less than or equal to 3.5 and polyprotic carboxylic acids having a pKa1 at 25° C. in water of less than or equal to 3.5.

As used herein with reference to the invention, the term “total carboxylic acid content” is used to describe the combined content of all carboxylic acids in the solid aerosol-generating substrate. For example, where the solid aerosol-generating substrate comprises a plurality of carboxylic acids consisting of benzoic acid and fumaric acid, the term “total carboxylic acid content” describes the combined benzoic acid content and fumaric acid content of the solid aerosol-generating substrate.

The solid aerosol-generating substrate may have a total carboxylic acid content of greater than or equal to 1 percent by weight, greater than or equal to 1.5 percent by weight, or greater than or equal to 2 percent by weight.

The solid aerosol-generating substrate may have a total carboxylic acid content of less than or equal to 8 percent by weight, less than or equal to 6 percent by weight, or less than or equal to 4 percent by weight.

The solid aerosol-generating substrate may have a total carboxylic acid content of between 0.5 percent by weight and 8 percent by weight, between 0.5 percent by weight and 6 percent by weight, or between 0.5 percent by weight and 4 percent by weight.

The solid aerosol-generating substrate may have a total carboxylic acid content of between 1 percent by weight and 8 percent by weight, between 1 percent by weight and 6 percent by weight, or between 1 percent by weight and 4 percent by weight.

The solid aerosol-generating substrate may have a total carboxylic acid content of between 1.5 percent by weight and 8 percent by weight, between 1.5 percent by weight and 6 percent by weight, or between 1.5 percent by weight and 4 percent by weight.

The solid aerosol-generating substrate may have a total carboxylic acid content of between 2 percent by weight and 8 percent by weight, between 2 percent by weight and 6 percent by weight, or between 2 percent by weight and 4 percent by weight.

The molar ratio of total carboxylic acid to nicotine in the solid aerosol-generating substrate may be greater than or equal to 0.5:1, greater than or equal to 1:1, greater than or equal to 1.5:1, or greater than or equal to 2:1.

The molar ratio of total carboxylic acid to nicotine in the solid aerosol-generating substrate may be less than or equal to 5:1, less than or equal to 4.5:1, less than or equal to 4:1, or less than or equal to 3.5:1.

The molar ratio of total carboxylic acid to nicotine in the solid aerosol-generating substrate may be between 0.5:1 and 5:1, between 0.5:1 and 4.5:1, between 0.5:1 and 4:1, or between 0.5:1 and 3.5:1.

The molar ratio of total carboxylic acid to nicotine in the solid aerosol-generating substrate may be between 1:1 and 5:1, between 1:1 and 4.5:1, between 1:1 and 4:1, or between 1:1 and 3.5:1.

The molar ratio of total carboxylic acid to nicotine in the solid aerosol-generating substrate may be between 1.5:1 and 5:1, between 1.5:1 and 4.5:1, between 1.5:1 and 4:1, or between 1.5:1 and 3.5:1.

The molar ratio of total carboxylic acid to nicotine in the solid aerosol-generating substrate may be between 2:1 and 5:1, between 2:1 and 4.5:1, between 2:1 and 4:1, or between 2:1 and 3.5:1.

The solid aerosol-generating substrate may have a fumaric acid content of greater than or equal to 0.5 percent by weight, greater than or equal to 1 percent by weight, greater than or equal to 1.5 percent by weight, or greater than or equal to 2 percent by weight.

The solid aerosol-generating substrate may have a fumaric acid content of less than or equal to 8 percent by weight, less than or equal to 6 percent by weight, or less than or equal to 4 percent by weight.

The solid aerosol-generating substrate may have a fumaric acid content of between 0.5 percent by weight and 8 percent by weight, between 0.5 percent by weight and 6 percent by weight, or between 0.5 percent by weight and 4 percent by weight.

The solid aerosol-generating substrate may have a fumaric acid content of between 1 percent by weight and 8 percent by weight, between 1 percent by weight and 6 percent by weight, or between 1 percent by weight and 4 percent by weight.

The solid aerosol-generating substrate may have a fumaric acid content of between 1.5 percent by weight and 8 percent by weight, between 1.5 percent by weight and 6 percent by weight, or between 1.5 percent by weight and 4 percent by weight.

The solid aerosol-generating substrate may have a fumaric acid content of between 2 percent by weight and 8 percent by weight, between 2 percent by weight and 6 percent by weight, or between 2 percent by weight and 4 percent by weight.

The molar ratio of fumaric acid to nicotine in the solid aerosol-generating substrate may be greater than or equal to 0.5:1, greater than or equal to 1:1, greater than or equal to 1.5:1, or greater than or equal to 2:1.

The molar ratio of fumaric acid to nicotine in the solid aerosol-generating substrate may be less than or equal to 4:1, or less than or equal to 3.5:1, less than or equal to 3:1, or less than or equal to 2.5:1.

The molar ratio of fumaric acid to nicotine in the solid aerosol-generating substrate may be between 0.5:1 and 4:1, between 0.5:1 and 3.5:1, between 0.5:1 and 3:1, or between 0.5:1 and 2.5:1.

The molar ratio of fumaric acid to nicotine in the solid aerosol-generating substrate may be between 1:1 and 4:1, between 1:1 and 3.5:1, between 1:1 and 3:1, or between 1:1 and 2.5:1.

The molar ratio of fumaric acid to nicotine in the solid aerosol-generating substrate may be between 1.5:1 and 4:1, between 1.5:1 and 3.5:1, between 1.5:1 and 3:1, or between 1.5:1 and 2.5:1.

The molar ratio of fumaric acid to nicotine in the solid aerosol-generating substrate may be between 2:1 and 4:1, between 2:1 and 3.5:1, between 2:1 and 3:1, or between 2:1 and 2.5:1.

The solid aerosol-forming substrate may comprise one or more cellulose based agents.

As used herein with reference to the invention, the term “cellulose based agent” is used to describe a cellulosic substance. The term “cellulose based film-forming agent” may be used to describe a cellulosic polymer capable, by itself or in the presence of an auxiliary thickening agent, of forming a continuous film.

Examples of cellulose based agents include cellulose based film-forming agents, cellulose based strengthening agents and cellulose based binding agents.

As used herein with reference to the invention, the term “total cellulose based agent” is used to describe the combined content of all cellulose based agents in the solid aerosol-forming substrate. For example, where the solid aerosol-forming substrate comprises a plurality of cellulose based agents consisting of a cellulose based film-forming agent, a cellulose based strengthening agent, and a cellulose based binding agent, the term “total cellulose based agent content” describes the combined cellulose based film-forming agent content, cellulose based strengthening agent content, and cellulose based binding agent content of the solid aerosol-forming substrate.

The solid aerosol-forming substrate may have a total cellulose based agent content of greater than or equal to 25 percent by weight, or greater than or equal to 30 percent by weight. Preferably, the solid aerosol-forming substrate has a total cellulose based agent content of greater than or equal to 35 percent by weight. The solid aerosol-forming substrate may have a total cellulose based agent content of greater than or equal to 36 percent by weight, greater than or equal to 38 percent by weight, or greater than or equal to 40 percent by weight.

The solid aerosol-forming substrate may have a total cellulose based agent content of less than or equal to 52 percent by weight, less than or equal to 50 percent by weight, less than or equal to 48 percent by weight, less than or equal to 46 percent by weight, or less than or equal to 44 percent by weight.

The solid aerosol-forming substrate may have a total cellulose based agent content of between 35 percent by weight and 52 percent by weight, between 35 percent by weight and 50 percent by weight, between 35 percent by weight and 48 percent by weight, between 35 percent by weight and 46 percent by weight, or between 35 percent by weight and 44 percent by weight.

The solid aerosol-forming substrate may comprise one or more cellulose based film-forming agents.

As used herein with reference to the invention, the term “cellulose based film-forming agent” is used to describe a cellulosic polymer capable, by itself or in the presence of an auxiliary thickening agent, of forming a continuous film.

Advantageously, the solid aerosol-forming substrate may comprise one or more cellulose based film-forming agents selected from carboxymethyl cellulose (CMC), ethylcellulose (EC), hydroxyethyl cellulose (HEC), hydroxyethyl methylcellulose (HEMC), hydroxypropyl cellulose (HPC), hydroxypropyl methylcellulose (HPMC), and methylcellulose (MC). Preferably, the solid aerosol-forming substrate comprises carboxymethyl cellulose (CMC) and hydroxypropyl methylcellulose (HPMC).

Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof.

More preferably, the cellulose based film-forming agent is selected from the group consisting of hydroxypropyl methylcellulose (HPMC), methylcellulose (MC), ethylcellulose (EC), and combinations thereof.

In particularly preferred embodiments, the cellulose based film-forming agent is HPMC.

The one or more cellulose based film-forming agents may act as a binding agent for the solid aerosol-forming substrate.

The solid aerosol-forming substrate may have a total cellulose based film-forming agent content of greater than or equal to 15 percent by weight, greater than or equal to 20 percent by weight, or greater than or equal to 25 percent by weight.

The solid aerosol-forming substrate may have a total cellulose based film-forming agent content of less than or equal to 40 percent by weight, less than or equal to 35 percent by weight, or less than or equal to 30 percent by weight.

The solid aerosol-forming substrate may have a total cellulose based film-forming agent content of between 10 percent by weight and 40 percent by weight, between 15 percent by weight and 35 percent by weight, or between 15 percent by weight and 30 percent by weight. The aerosol-forming film may have a cellulose based film-forming agent content of between 10 percent and 40 percent by weight, or between 15 percent and 35 percent by weight, or between 20 percent and 30 percent by weight, on a dry weight basis.

The solid aerosol-forming substrate may comprise one or more cellulose based strengthening agents.

Inclusion of one or more cellulose based strengthening agents in the solid aerosol-forming substrate may advantageously increase the tensile strength of the solid aerosol-forming substrate. In particular, where the solid aerosol-forming substrate is a solid aerosol-forming film, inclusion of one or more cellulose based strengthening agents in the solid aerosol-forming substrate may advantageously increase the tensile strength of the solid aerosol-forming film. A solid aerosol-forming substrate having a higher tensile strength may advantageously be less likely to deteriorate or break during manufacture and storage.

Advantageously, the solid aerosol-forming substrate may comprise one or more cellulose based strengthening agents selected from cellulose fibres, cellulose powder, and microcrystalline cellulose (MCC). Preferably, the cellulose based strengthening agent is selected from the group consisting of cellulose fibres, microcrystalline cellulose (MCC), cellulose powder, and combinations thereof.

Preferably, the solid aerosol-forming substrate comprises cellulose fibres. Cellulose fibres may be particularly effective at increasing the tensile strength of the solid aerosol-forming substrate.

The aerosol-forming film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The solid aerosol-forming substrate may have a total cellulose based strengthening agent content of greater than or equal to 5 percent by weight, greater than or equal to 10 percent by weight, or greater than or equal to 15 percent by weight.

As used herein with reference to the invention, the term “total cellulose based strengthening agent content” is used to describe the combined content of all cellulose based strengthening agents in the solid aerosol-forming substrate.

The solid aerosol-forming substrate may have a total cellulose based strengthening agent content of less than or equal to 30 percent by weight, less than or equal to 25 percent by weight, or less than or equal to 20 percent by weight.

The solid aerosol-forming substrate may have a total cellulose based strengthening agent content of between 5 percent by weight and 30 percent by weight, between 5 percent by weight and 25 percent by weight, or between 5 percent by weight and 20 percent by weight.

The aerosol-forming film may further comprise a carboxymethyl cellulose, preferably sodium carboxymethyl cellulose.

The aerosol-forming film may have a carboxymethyl cellulose content of between 1 percent and 15 percent by weight, or between 2 percent and 12 percent by weight, or between 4 percent and 10 percent by weight on a dry weight basis.

The solid aerosol-forming substrate may comprise water.

The solid aerosol-forming substrate may have a water content of greater than or equal to 5 percent by weight, greater than or equal to 10 percent by weight, greater than or equal to percent by weight, or greater than or equal to 17 percent by weight based on the total weight of the solid aerosol-forming substrate.

The solid aerosol-forming substrate may have a water content of less than or equal to percent by weight, less than or equal to 30 percent by weight, or less than or equal to 25 percent by weight based on the total weight of the solid aerosol-forming substrate.

The solid aerosol-forming substrate may have a water content of between 5 percent by weight and 35 percent by weight, between 5 percent by weight and 30 percent by weight, or between 5 percent by weight and 25 percent by weight based on the total weight of the solid aerosol-forming substrate.

The solid aerosol-forming substrate may comprise one or more non-cellulose based thickening agents.

As used herein with reference to the invention, the term “non-cellulose based thickening agent” is used to describe a non-cellulosic substance that, when added to an aqueous or non-aqueous liquid composition, increases the viscosity of the liquid composition without substantially modifying its other properties. The one or more non-cellulose based thickening agents may increase stability, and improve suspension of components in the liquid composition. A thickening agent may also be referred to as a “thickener” or a “rheology modifier” or “viscosifying agent”.

The solid aerosol-forming substrate may comprise one or more non-cellulose based thickening agents selected from alginates, gellan gum, guar gum, gum arabic, locust bean gum, pectins, starches, and xanthan gum.

The solid aerosol-forming substrate may have a total non-cellulose based thickening agent content of greater than or equal to 1 percent by weight, greater than or equal to 2 percent by weight, or greater than or equal to 3 percent by weight.

The solid aerosol-forming substrate may have a total non-cellulose based thickening agent content of less than or equal to 10 percent by weight, less than or equal to 8 percent by weight, or less than or equal to 6 percent by weight.

The solid aerosol-forming substrate may have a total non-cellulose based thickening agent content of between 1 percent by weight and 10 percent by weight, between 1 percent by weight and 8 percent by weight, or between 1 percent by weight and 6 percent by weight.

The solid aerosol-forming substrate may comprise one or more flavourants.

Suitable flavourants are known in the art and include, but are not limited to, menthol.

As used herein with reference to the invention, the term “menthol” is used to describe the compound 2-isopropyl-5-methylcyclohexanol in any of its isomeric forms.

The solid aerosol-forming substrate may have a total flavourant content of greater than or equal to 0.5 percent by weight, greater than or equal to 1 percent by weight, greater than or equal to 2 percent by weight, or greater than or equal to 3 percent by weight.

The solid aerosol-forming substrate may have a total flavourant content of less than or equal to 6 percent by weight, less than or equal to 5 percent by weight, or less than or equal to 4 percent by weight.

The solid aerosol-forming substrate may have a total flavourant content of between 0.5 percent by weight and 6 percent by weight, between 0.5 percent by weight and 5 percent by weight, or between 0.5 percent by weight and 4 percent by weight.

The solid aerosol-forming substrate may have a total flavourant content of between 1 percent by weight and 6 percent by weight, between 1 percent by weight and 5 percent by weight, or between 1 percent by weight and 4 percent by weight.

The solid aerosol-forming substrate may be a substantially tobacco-free solid aerosol-forming substrate.

As used herein with reference to the invention, the term “substantially tobacco-free solid aerosol-forming substrate” is used to describe a solid aerosol-forming substrate having a tobacco content of less than 1 percent by weight. For example, the solid aerosol-forming substrate may have a tobacco content of less than 0.75 percent by weight, less than 0.5 percent by weight, or less than 0.25 percent by weight.

The solid aerosol-forming substrate may be a tobacco-free aerosol-forming film.

As used herein with reference to the invention, the term “tobacco-free solid aerosol-forming substrate” is used to describe a solid aerosol-forming substrate having a tobacco content of 0 percent by weight.

The aerosol-forming film preferably comprises nicotine.

As used herein with reference to the invention, the term “nicotine” is used to describe nicotine, a nicotine base or a nicotine salt. In embodiments in which the aerosol-forming film comprises a nicotine base or a nicotine salt, the amounts of nicotine recited herein are the amount of free base nicotine or amount of protonated nicotine, respectively.

The aerosol-forming film may comprise natural nicotine or synthetic nicotine.

The nicotine-containing aerosol-forming substrate may be a nicotine salt matrix.

The aerosol-forming film may comprise one or more monoprotic nicotine salts.

As used herein with reference to the invention, the term “monoprotic nicotine salt” is used to describe a nicotine salt of a monoprotic acid.

Preferably, the aerosol-forming film comprises at least 0.5 percent by weight of nicotine on a dry weight basis. More preferably, the aerosol-forming film comprises at least 1 percent by weight of nicotine on a dry weight basis. Even more preferably, the aerosol-forming film comprises at least 2 percent by weight of nicotine on a dry weight basis. In addition, or as an alternative, the aerosol-forming film preferably comprises less than 10 percent by weight of nicotine on a dry weight basis. More preferably, the aerosol-forming film comprises less than 8 percent by weight of nicotine on a dry weight basis. More preferably, the aerosol-forming film comprises less than 6 percent by weight of nicotine on a dry weight basis.

For example, the aerosol-forming film may comprise between 0.5 percent and 10 percent by weight of nicotine, or between 1 percent and 8 percent by weight of nicotine, or between 2 percent and 6 percent by weight of nicotine, on a dry weight basis.

The aerosol-forming film may be a substantially tobacco-free aerosol-forming film.

In preferred embodiments, the aerosol-forming film comprises an acid. More preferably, the aerosol-forming film comprises one or more organic acids. Even more preferably, the aerosol-forming film comprises one or more carboxylic acids. In particularly preferred embodiments, the acid is lactic acid, benzoic acid, fumaric acid or levulinic acid.

Preferably, the aerosol-forming film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-forming film may have a thickness from about 0.1 millimeter to about 1 millimeter, more preferably from about 0.1 millimeter to about 0.75 millimeter, even more preferably from about 0.1 millimeter to about 0.5 millimeter. In particularly preferred embodiments, a layer of the film-forming composition is formed that has a thickness from about 50 micrometers to 400 micrometers, more preferably from about 100 micrometers to 200 micrometers.

The aerosol-forming film may optionally be provided on a suitable carrier element.

The aerosol-forming substrate may comprise a gel composition The aerosol-forming substrate may comprise a gel composition that includes nicotine, at least one gelling agent and the aerosol former. The gel composition is preferably substantially tobacco free.

The preferred weight ranges for nicotine in the gel composition are the same as those defined above in relation to aerosol-forming films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25° C., 50 percent by weight water/50 percent by weight glycerol mixture, in an amount of 0.3 percent by weight, increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the aerosol-forming substrate comprises a porous medium loaded with the gel composition. Advantages of a porous medium loaded with the gel composition is that the gel composition is retained within the porous medium, and this may aid manufacturing, storage or transport of the gel composition. It may assist in keeping the desired shape of the gel composition, especially during manufacture, transport, or use.

The term “porous” is used herein to refer to a material that provides a plurality of pores or openings that allow the passage of air through the material.

The porous medium may be any suitable porous material able to hold or retain the gel composition. Ideally the porous medium can allow the gel composition to move within it. In specific embodiments the porous medium comprises natural materials, synthetic, or semi-synthetic, or a combination thereof. In specific embodiments the porous medium comprises sheet material, foam, or fibres, for example loose fibres; or a combination thereof. In specific embodiments the porous medium comprises a woven, non-woven, or extruded material, or combinations thereof. Preferably the porous medium comprises, cotton, paper, viscose, PLA, or cellulose acetate, of combinations thereof. Preferably the porous medium comprises a sheet material, for example, cotton or cellulose acetate. In a particularly preferred embodiment, the porous medium comprises a sheet made from cotton fibres.

The porous medium may be crimped or shredded. The porous medium may be in the form of a sheet, thread or tubular element.

The aerosol-forming substrate may have added a portion of plant material, for example tobacco material, as long as the aerosol former content does not fall below 5 percent by weight, preferably does not fall below 35 percent by weight.

The aerosol-forming substrate may comprise tobacco particles. With reference to the present invention, the term “tobacco particles” describes particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of the invention and are not included in the percentage of particulate plant material.

The aerosol-forming substrate may comprise plant material and an aerosol former. The plant material may be a plant material comprising an alkaloid, more preferably a plant material comprising nicotine, and more preferably a tobacco-containing material.

Alkaloids are a class of naturally occurring nitrogen-containing organic compounds. Alkaloids are found mostly in plants, but are also found in bacteria, fungi and animals. Examples of alkaloids include, but are not limited to, caffeine, nicotine, theobromine, atropine and tubocurarine. A preferred alkaloid is nicotine, which may be found in tobacco.

As used herein, the term “tobacco material” is used to describe any material comprising tobacco, including, but not limited to, tobacco leaf, tobacco rib, tobacco stem, tobacco stalk, tobacco dust, expanded tobacco, reconstituted tobacco material and homogenised tobacco material.

As used herein, the term “flavourant” refers to a composition having organoleptic properties, which provide a sensory experience to the user, for example to enhance the flavour of aerosol. A flavourant can be used to deliver a gustatory sensation (taste), an olfactory sensation (smell), or both a gustatory and an olfactory sensation to the user, for example when inhaling the aerosol.

The aerosol-forming substrate may comprise, on a dry weight basis, an aerosol former content of at least 35 percent by weight, a tobacco content of less than 35 percent by weight, and between 0.5 percent by weight and 4 percent by weight of one or more carboxylic acids. The aerosol-forming substrate may comprise, on a dry weight basis, an aerosol former content of at least 35 percent by weight, a tobacco content of less than 35 percent by weight, between 0.5 percent by weight and 4 percent by weight of one or more carboxylic acids, and less than 4 percent by weight of nicotine.

The aerosol-forming substrate may be a solid aerosol-forming film having the composition as shown in Table I below.

TABLE I

| Component | | % by weight |
|---|---|---|
| Hydroxypropyl | Cellulose based | 22.64 |
| methylcellulose | film-forming agent | |
| Cellulose fibres | Cellulose based | 16.98 |
| | strengthening agent | |
| Carboxymethyl | Cellulose based | 5.66 |
| cellulose | film-forming agent | |
| Nicotine | | 1.53 |
| Fumaric Acid | Carboxylic acid | 2.23 |
| Glycerine | Aerosol former | 50.96 |

| | |
|---|---|
| Molar ratio of total carboxylic acid to nicotine | 2:1 |

The solid aerosol-generating film may be prepared by:
(1) mixing the components shown in Table I together with water using agitation to form a slurry;
(2) casting a layer of the slurry onto a plane surface to form a film having a thickness of between 600 and 1000 micrometers;
(3) leaving the film on the plane surface to solidify; and
(3) drying the film by heating the film to 140 degrees Celsius for 8 minutes to form a solid aerosol-forming film.

The aerosol-forming substrate may be a solid aerosol-forming film having the composition as shown in Table I below, but where the fumaric acid is partially or completely substituted by one or more other carboxylic acids. For example, the fumaric acid may be partially or completely substituted by one or more carboxylic acids selected from malic acid, maleic acid, lactic acid, and benzoic acid.

The aerosol-forming substrate may be provided in form of a film or gel.

The aerosol-forming substrate may be provided in form of a film having a thickness of from about 0.1 millimeter to about 1 millimeter, preferably from about 0.05 millimeter to about 0.75 millimeter, more preferably from about 0.05 millimeter to about 0.5 millimeter, more preferably from 50 micrometers to 400 micrometers, more preferably from 100 micrometers to 200 micrometers.

The total mass of aerosol-forming substrate in the aerosol-generating article may be between 200 milligrams and 400 milligrams, preferably between 240 milligrams and 340 milligrams, more preferably between 250 milligrams and 290 milligrams, more preferably between 260 milligrams and 280 milligrams.

The portion of the aerosol-generating article filled by the aerosol-forming substrate may be denoted as aerosol-forming substrate portion.

The aerosol-forming substrate portion may define a substantially cylindrical shape. The cylindrical shape of the aerosol-forming substrate portion may have a diameter in a range from about 3 millimeters to about 10 millimeters, preferably from about 6 millimeters to about 8 millimeters, more preferably from about 6.5 millimeters to about 7.5 millimeters.

The aerosol-generating article may comprise one or more susceptor elements. The one or more susceptor elements may be comprised within the aerosol-forming substrate portion. For example, one or more elongate susceptor elements may be arranged substantially longitudinally within the aerosol-forming substrate portion and in thermal contact with the aerosol-forming substrate.

As used herein, the terms “susceptor” and “susceptor element” refer to an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or cartridge. In this manner, the aerosol-forming substrate is heated by the susceptor such that an aerosol is formed.

The susceptor element may be formed from any material that can be inductively heated to a temperature sufficient to generate an aerosol from the aerosol-forming substrate. Preferred susceptor elements comprise a metal or carbon.

A preferred susceptor element may comprise or consist of a ferromagnetic material, for example a ferromagnetic alloy, ferritic iron, or a ferromagnetic steel or stainless steel. A suitable susceptor element may be, or comprise, aluminium.

Suitable susceptor elements may comprise a non-metallic core with a metal layer disposed on the non-metallic core, for example metallic tracks formed on a surface of a ceramic core. A susceptor element may have a protective external layer, for example a protective ceramic layer or protective glass layer encapsulating the susceptor element. The susceptor element may comprise a protective coating formed by a glass, a ceramic, or an inert metal, formed over a core of susceptor element material.

The susceptor element may be arranged in thermal contact with the aerosol-forming substrate of the aerosol-forming substrate portion in which the susceptor element is incorporated. Thus, when the susceptor element heats up the aerosol-forming substrate is heated up and an aerosol is formed. Preferably the susceptor element is arranged in direct physical contact with the aerosol-forming substrate, for example within the aerosol-forming substrate.

The aerosol-forming substrate portion may comprise the susceptor element. The susceptor element may be at least partly circumscribed by the aerosol-forming substrate. The susceptor element may be completely surrounded by the aerosol-forming substrate. The susceptor element may extend along substantially the entire length of the aerosol-forming substrate portion. This may provide an optimized distribution of heat within the aerosol-forming substrate when the susceptor element is heated. The susceptor element may comprise a flat planar portion. The susceptor element may be a flat planar susceptor strip. The susceptor element may comprise a metal or an alloy. The susceptor element may comprise aluminum.

As used herein, the term “flat planar” relates to a generally cuboid shape having a height being significantly smaller than a width and a length. For example, the width and length each may be at least twice the height of the cuboid. The height of the flat planar cuboid may also be referred to as the thickness of the susceptor element, or of the flat planar portion of the susceptor element.

The susceptor element may generally have a thickness from 0.01 millimeter to 2 millimeters, for example from 0.5 millimeter to 2 millimeters. In some embodiments, the susceptor element preferably has a thickness from 10 micrometers to 500 micrometers, more preferably from 10 micrometers to 100 micrometers. The susceptor element may have a thickness from about 35 micrometers to about 85 micrometers. The susceptor element may have a thickness from about 45 micrometers to about 75 micrometers. The susceptor element may have a thickness from about 55 micrometers to about 65 micrometers.

The susceptor element may be an elongate susceptor arranged substantially longitudinally within the aerosol-forming substrate portion.

When used for describing the susceptor element, the term “elongate” denotes that the susceptor element has a length dimension that is greater than its width dimension or its thickness dimension, for example greater than twice its width dimension or its thickness dimension.

The susceptor element may be arranged substantially longitudinally within the aerosol-forming substrate portion. This means that the length dimension of the elongate susceptor is arranged to be approximately parallel to the longitudinal direction of the aerosol-forming substrate, for example within plus or minus 10 degrees of parallel to the longitudinal direction of the aerosol-forming substrate. The elongate susceptor may be positioned in a radially central position within the aerosol-forming substrate portion and extend along the longitudinal axis of the aerosol-forming substrate portion.

The susceptor element may be in the form of a pin, rod, strip or blade.

The susceptor element may have a length from about 5 millimeters to about 15 millimeters, for example from about 6 millimeters to about 12 millimeters, more preferably from about 8 millimeters to about 10 millimeters. The susceptor element may have a length of about 11 millimeters.

The susceptor element may have a width of at least about 1 millimeter, more preferably at least about 2 millimeters. Typically, the susceptor element may have a width of up to 8 millimeters, preferably of less than or equal to about 6 millimeters.

When the susceptor element has a constant cross-section, for example a circular cross-section, it may have a width or diameter from about 1 millimeter to about 5 millimeters.

When the susceptor element has the form of a strip or blade, the strip or blade may have a rectangular cross-section having a width of preferably from about 2 millimeters to about 8 millimeters, more preferably from about 3 millimeters to about 6 millimeters. A susceptor element in the form of a strip of blade may have a width of about 4 millimeters.

The elongate susceptor may have a thickness from about 57 micrometers to about 63 micrometers. Even more preferably, the elongate susceptor may have a thickness from about 58 micrometers to about 62 micrometers. Most preferably, the elongate susceptor has a thickness of about 60 micrometers.

The aerosol-generating article may comprise a downstream section located downstream of the aerosol-forming substrate portion. The downstream section is preferably located immediately downstream of the aerosol-forming substrate portion. The downstream section of the aerosol-generating article preferably extends between the aerosol-forming substrate portion and the downstream end of the aerosol-generating article. The downstream section may comprise one or more elements, each of which will be described in more detail within the present disclosure.

A length of the downstream section may be at least 10 millimeters, or at least 20 millimeters, or at least 25 millimeters, or at least 30 millimeters.

A length of the downstream section may be less than 70 millimeters, or less than 60 millimeters, or less than 50 millimeters.

For example, a length of the downstream section may be between 20 millimeters and 70 millimeters, or between 25 millimeters and 60 millimeters, or between 30 millimeters and 50 millimeters.

The downstream section of an aerosol-generating article according to the present invention preferably comprises a hollow tubular cooling element provided downstream of the aerosol-forming substrate portion. The hollow tubular cooling element may advantageously provide an aerosol-cooling element for the aerosol-generating article.

The hollow tubular cooling element may be provided immediately downstream of the aerosol-forming substrate portion. In other words, the hollow tubular cooling element may abut a downstream end of the aerosol-forming substrate portion. The hollow tubular cooling element may define an upstream end of the downstream section of the aerosol-generating article. The downstream end of the aerosol-generating article may coincide with the downstream end of the downstream section. In some embodiments, the downstream section of the aerosol-generating article comprises a single hollow tubular element. In other words, the downstream section of the aerosol-generating article may comprise only one hollow tubular element. In other embodiments, the downstream section comprises two or more hollow tubular elements, as described below.

As used throughout the present disclosure, the term “hollow tubular element” denotes a generally elongate element defining a lumen or airflow passage along a longitudinal axis thereof. In particular, the term “tubular” will be used in the following with reference to a tubular element having a substantially cylindrical cross-section and defining at least one airflow conduit establishing an uninterrupted fluid communication between an upstream end of the tubular element and a downstream end of the tubular element. However, it will be understood that alternative geometries (for example, alternative cross-sectional shapes) of the tubular element may be possible. The hollow tubular cooling element may be an individual, discrete element of the aerosol-generating article which has a defined length and thickness.

In the context of the present invention, a hollow tubular cooling element provides an unrestricted flow channel. This means that the hollow tubular cooling element provides a negligible level of resistance to draw (RTD). The term “negligible level of RTD” is used to describe an RTD of less than 1 millimeters of water gauge per 10 millimeters of length of the hollow tubular cooling element, preferably less than 0.4 millimeters of water gauge per 10 millimeters of length of the hollow tubular cooling element, more preferably less than 0.1 millimeters of water gauge per 10 millimeters of length of the hollow tubular cooling element.

The RTD of a hollow tubular cooling element is preferably less than or equal to 10 millimeters of water gauge, or less than or equal to 5 millimeters of water gauge, or less than or equal to 2.5 millimeters of water gauge, or less than or equal to 2 millimeters of water gauge, or less than or equal to 1 millimeter of water gauge.

The RTD of a hollow tubular cooling element may be at least 0 millimeters of water gauge, or at least 0.25 millimeters of water gauge or at least 0.5 millimeters of water gauge or at least 1 millimeter of water gauge.

In aerosol-generating articles in accordance with the present invention the overall RTD of the article depends essentially on the RTD of the rod and optionally on the RTD of the downstream and/or upstream elements. This is because the hollow tubular cooling element is substantially empty and, as such, substantially only marginally contribute to the overall RTD of the aerosol-generating article.

The flow channel should therefore be free from any components that would obstruct the flow of air in a longitudinal direction. Preferably, the flow channel is substantially empty and particularly preferably the flow channel is empty.

As will be described in greater detail within the present disclosure, the aerosol-generating article may comprise a ventilation zone at a location along the downstream section. In some embodiments, the aerosol-generating article may comprise a ventilation zone at a location along the hollow tubular cooling element. Such, or any, ventilation zone may extend through the peripheral wall of the hollow tubular cooling element. As such, fluid communication is established between the flow channel internally defined by the hollow tubular cooling element and the outer environment. The ventilation zone is further described within the present disclosure.

The length of the hollow tubular cooling element may be at least 15 millimeters, or at least 20 millimeters, or at least 25 millimeters. The length of the hollow tubular cooling element may be less than 50 millimeters, or less than 45 millimeters, or less than 40 millimeters. For example, the length of the hollow tubular cooling element may be between 15 millimeters and 50 millimeters, or between 20 millimeters and 45 millimeters, or between 20 millimeters and millimeters, or between 20 millimeters and 30 millimeters, or between 25 millimeters and millimeters.

A relatively long hollow tubular cooling element provides and defines a relatively long internal cavity within the aerosol-generating article and downstream of the aerosol-forming substrate portion. Providing an empty cavity downstream (preferably, immediately downstream) of the aerosol-forming substrate enhances the nucleation of aerosol particles generated by the substrate. Providing a relatively long cavity maximises such nucleation benefits, thereby improving aerosol formation and cooling.

The wall thickness of the hollow tubular cooling element may between 100 micrometers and 2 millimeters, or between 150 micrometers and 1.5 millimeters, or between 200 micrometers and 1.25 millimeters.

The hollow tubular cooling element preferably has an external diameter that is approximately equal to the external diameter of the aerosol-generating article.

The hollow tubular cooling element may have an external diameter of between 5 millimeters and 10 millimeters, for example of between 5.5 millimeters and 9 millimeters or of between 6 millimeters and 8 millimeters. In certain embodiments, the hollow tubular cooling element has an external diameter of less than 7 millimeters.

The hollow tubular cooling element may have an internal diameter. Preferably, the hollow tubular cooling element has a constant internal diameter along a length of the hollow tubular cooling element. However, the internal diameter of the hollow tubular cooling element may vary along the length of the hollow tubular cooling element.

The hollow tubular cooling element may have an internal diameter of at least 2 millimeters. For example, the hollow tubular cooling element may have an internal diameter of at least 3 millimeters, at least 4 millimeters, or at least 5 millimeters.

The provision of a hollow tubular cooling element having an internal diameter as set out above may advantageously provide sufficient rigidity and strength to the hollow tubular cooling element.

The hollow tubular cooling element may have an internal diameter of no more than 10 millimeters. For example, the hollow tubular cooling element may have an internal diameter of no more than 9 millimeters, no more than 8 millimeters, or no more than 7 millimeters.

The provision of a hollow tubular cooling element having an internal diameter as set out above may advantageously reduce the resistance to draw of the hollow tubular cooling element.

The hollow tubular cooling element may have an internal diameter of between 2 millimeters and 10 millimeters, between 3 millimeters and 9 millimeters, between 4 millimeters and 8 millimeters, or between 5 millimeters and 7 millimeters.

The lumen or cavity of the hollow tubular cooling element may have any cross sectional shape. The lumen of the hollow tubular cooling element may have a circular cross sectional shape.

The hollow tubular cooling element may comprise a paper-based material. The hollow tubular cooling element may comprise at least one layer of paper. The paper may be very rigid paper. The paper may be crimped paper, such as crimped heat resistant paper or crimped parchment paper.

Preferably, the hollow tubular cooling element may comprise cardboard. The hollow tubular cooling element may be a cardboard tube. The hollow tubular cooling element may be formed from cardboard. Advantageously, cardboard is a cost-effective material that provides a balance between being deformable in order to provide ease of insertion of the article into an aerosol-generating device and being sufficiently stiff to provide suitable engagement of the article with the interior of the device. A cardboard tube may therefore provide suitable resistance to deformation or compression during use.

The hollow tubular cooling element may be a paper tube. The hollow tubular cooling element may be a tube formed from spirally wound paper. The hollow tubular cooling element may be formed from a plurality of layers of the paper. The paper may have a basis weight of at least 50 grams per square meter, at least 60 grams per square meter, at least 70 grams per square meter, or at least 90 grams per square meter.

The hollow tubular cooling element may comprise a polymeric material. For example, the hollow tubular cooling element may comprise a polymeric film. The polymeric film may comprise a cellulosic film. The hollow tubular cooling element may comprise low density polyethylene (LDPE) or polyhydroxyalkanoate (PHA) fibres. The hollow tube may comprise cellulose acetate tow.

Where the hollow tubular cooling element comprises cellulose acetate tow, the cellulose acetate tow may have a denier per filament of between 2 and 4 and a total denier of between 25 and 40.

Preferably, the aerosol-generating article according to the present invention comprises a ventilation zone at a location along the downstream section. In more detail, in those embodiments wherein the downstream section comprises a hollow tubular cooling element, the ventilation zone may be provided at a location along the hollow tubular cooling element. Alternatively or in addition, in those embodiments where the downstream section comprises a downstream hollow tubular element, as described below, the ventilation zone may be provided at a location along the downstream hollow tubular element.

As such, a ventilated cavity is provided downstream of the aerosol-forming substrate portion. This provides several potential technical benefits. First of all, the inventors have found that one such ventilated hollow tubular cooling element provides a particularly efficient cooling of the aerosol. Secondly, the inventors have surprisingly found that such rapid cooling of the volatile species released upon heating the aerosol-forming substrate enhances nucleation of aerosol particles.

The ventilation zone may typically comprise a plurality of perforations through the peripheral wall of the hollow tubular cooling element. Preferably, the ventilation zone comprises at least one circumferential row of perforations. In some embodiments, the ventilation zone may comprise two circumferential rows of perforations. For example, the perforations may be formed online during manufacturing of the aerosol-generating article. Preferably, each circumferential row of perforations comprises from 8 to 30 perforations.

An aerosol-generating article in accordance with the present invention may have a ventilation level of at least 40 percent. Increasing the ventilation level may increase the level of aerosol cooling. However, increasing the ventilation level may mean that less air is admitted into the aerosol-generating article via the upstream end of the aerosol-generating article which then flows through the aerosol-forming substrate portion. The ventilation level may thereby be selected based on a desired temperature and composition of the aerosol delivered to a user.

The aerosol-generating article preferably has a ventilation level of at least 45 percent, more preferably at least 50 percent, more preferably at least 60 percent, more preferably at least 70 percent.

An aerosol-generating article in accordance with the present invention may have a ventilation level of less than or equal to 90 percent, more preferably less than or equal to 85 percent, more preferably less than or equal to 80 percent.

Thus, an aerosol-generating article in accordance with the present invention may have a ventilation level from 45 percent to 90 percent, more preferably from 45 percent to 85 percent, even more preferably from 45 percent to 80 percent. The aerosol-generating article in accordance with the present invention may have a ventilation level from 50 percent to 90 percent, preferably from 50 percent to 85 percent, more preferably from 50 percent to 80 percent. The aerosol-generating article in accordance with the present invention may have a ventilation level from 60 percent to 90 percent, preferably from 60 percent to 85 percent, more preferably from 60 percent to 80 percent. The aerosol-generating article in accordance with the present invention may have a ventilation level from 70 percent to 90 percent, preferably from 70 percent to 85 percent, more preferably from 70 percent to 80 percent.

For example, the aerosol-generating article may have a ventilation level of about 75 percent.

As discussed in the present disclosure, the downstream section may comprise a downstream filter segment. The downstream filter segment may extend to a downstream end of the downstream section. The downstream filter segment may be located at the downstream end of the aerosol-generating article. The downstream end of the downstream filter segment may define the downstream end of the aerosol-generating article. The downstream filter segment may also be referred to as mouth-end filter.

The downstream filter segment may be located downstream of a hollow tubular cooling element, which is described above. The downstream filter segment may extend between the hollow tubular cooling element and the downstream end of the aerosol-generating article.

The downstream filter segment is preferably a solid plug, which may also be described as a ‘plain’ plug and is non-tubular. The filter segment therefore preferably has a substantially uniform transverse cross section.

The downstream filter segment is preferably formed of a fibrous filtration material. The fibrous filtration material may be for filtering the aerosol that is generated from the aerosol-forming substrate. Suitable fibrous filtration materials would be known to the skilled person. Particularly preferably, the at least one downstream filter segment comprises a cellulose acetate filter segment formed of cellulose acetate tow.

In certain preferred embodiments, the downstream section includes a single downstream filter segment. In alternative embodiments, the downstream section includes two or more downstream filter segments axially aligned in an abutting end to end relationship with each other.

The downstream filter segment may optionally comprise a flavourant, which may be provided in any suitable form. For example, the downstream filter segment may comprise one or more capsules, beads or granules of a flavourant, or one or more flavour loaded threads or filaments.

Preferably, the downstream filter segment has a low particulate filtration efficiency.

Preferably, the downstream filter segment is circumscribed by a plug wrap. Preferably, the downstream filter segment is unventilated such that air does not enter the aerosol-generating article along the downstream filter segment.

The downstream filter segment is preferably connected to one or more of the adjacent upstream components of the aerosol-generating article by means of a tipping wrapper.

The downstream filter segment preferably has an external diameter that is approximately equal to the external diameter of the aerosol-generating article. The external diameter of a downstream filter segment may be substantially the same as the external diameter of the hollow tubular cooling element.

The external diameter of the downstream filter segment may be between 5 millimeters and 10 millimeters, or between 5.5 millimeters and 9 millimeters, or between 6 millimeters and 8 millimeters. In certain embodiments, the external of the downstream filter segment is less than 7 millimeters.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 normally carried out at a volumetric flow rate of 17.5 milliliters per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

The resistance to draw (RTD) may be expressed with the units of pressure “millimeter(s) of water gauge” (mmWG).

The resistance to draw (RTD) of the downstream section may be at least 0 millimeters of water gauge. The RTD of the downstream section may be at least 3 millimeters of water gauge. The RTD of the downstream section may be at least 6 millimeters of water gauge. The RTD of the downstream section may be no greater than 12 millimeters of water gauge. The RTD of the downstream section may be no greater than 11 millimeters of water gauge. The RTD of the downstream section may be no greater than 10 millimeters of water gauge.

The resistance to draw (RTD) characteristics of the downstream section may be wholly or mostly attributed to the RTD characteristics of the downstream filter segment of the downstream section. In other words, the RTD of the downstream filter segment of the downstream section may wholly define the RTD of the downstream section.

The resistance to draw (RTD) of the downstream filter segment may be at least 0 millimeters of water gauge, or at least 3 millimeters of water gauge, or at least 6 millimeters of water gauge. The RTD of the downstream filter segment may be no greater than 12 millimeters of water gauge, or no greater than 11 millimeters of water gauge, or no greater than 10 millimeters of water gauge.

As mentioned above, the downstream filter segment may be formed of a fibrous filtration material. The downstream filter segment may be formed of a porous material. The downstream filter segment may be formed of a biodegradable material. The downstream filter segment may be formed of a cellulose material, such as cellulose acetate. For example, a downstream filter segment may be formed from a bundle of cellulose acetate fibres having a denier per filament between 10 and 15. For example, a downstream filter segment formed from relatively low density cellulose acetate tow, such as cellulose acetate tow comprising fibres of 12 denier per filament.

The downstream filter segment may be formed of a polylactic acid based material. The downstream filter segment may be formed of a bioplastic material, preferably a starch-based bioplastic material. The downstream filter segment may be made by injection moulding or by extrusion. Bioplastic-based materials are advantageous because they are able to provide downstream filter segment structures which are simple and cheap to manufacture with a particular and complex cross-sectional profile, which may comprise a plurality of relatively large air flow channels extending through the downstream filter segment material, that provides suitable RTD characteristics.

The length of the downstream filter segment may be at least 5 millimeters, or at least millimeters. The length of the downstream filter segment may be less than 25 millimeters, or less than 20 millimeters. For example, the length of the downstream filter segment may be between 5 millimeters and 25 millimeters, or between 10 millimeters and 25 millimeters, or between 5 millimeters and 20 millimeters, or between 10 millimeters and 20 millimeters.

The downstream section may further comprise one or more additional hollow tubular elements.

In certain embodiments, the downstream section may comprise a hollow tubular support element upstream of the hollow tubular cooling element described above. Preferably, the hollow tubular support element abuts the downstream end of the aerosol-forming substrate portion. Preferably, the hollow tubular support element abuts the upstream end of the hollow tubular cooling element. Preferably, the hollow tubular support element and the hollow tubular cooling element are adjacent to each other and together provide a hollow tubular section within the downstream section.

The hollow tubular support element may be formed from any suitable material or combination of materials. For example, the support element may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, the support element is formed from cellulose acetate. Other suitable materials include polyhydroxyalkanoate (PHA) fibres. In a preferred embodiment, the hollow tubular support element comprises a hollow acetate tube.

The hollow tubular support element preferably has an external diameter that is approximately equal to the external diameter of the aerosol-generating article.

The hollow tubular support element may have an external diameter of between 5 millimeters and 10 millimeters, for example of between 5.5 millimeters and 9 millimeters or of between 6 millimeters and 8 millimeters. In a preferred embodiment, the hollow tubular support element has an external diameter of less than 7 millimeters.

The hollow tubular support element may have a wall thickness of at least 1 millimeter, preferably at least 1.5 millimeters, more preferably at least 2 millimeters.

The hollow tubular support element may have a length of at least 5 millimeters. Preferably, the support element has a length of at least 6 millimeters, more preferably at least 7 millimeters.

The hollow tubular support element may have a length of less than 15 millimeters. Preferably, the hollow tubular support element has a length of less than 12 millimeters, more preferably less than 10 millimeters.

In some embodiments, the hollow tubular support element has a length from 5 millimeters to 15 millimeters, preferably from 6 millimeters to 15 millimeters, more preferably from 7 millimeters to 15 millimeters. In other embodiments, the hollow tubular support element has a length from 5 millimeters to 12 millimeters, preferably from 6 millimeters to 12 millimeters, more preferably from 7 millimeters to 12 millimeters. In further embodiments, the support element has a length from 5 millimeters to 10 millimeters, preferably from 6 millimeters to 10 millimeters, more preferably from 7 millimeters to 10 millimeters.

Alternatively or in addition to the hollow tubular support element, the downstream section may further comprise a downstream hollow tubular element downstream of the hollow tubular cooling element. The downstream hollow tubular element may be provided immediately adjacent to the hollow tubular cooling element. Alternatively and preferably, the downstream hollow tubular element is separated from the hollow tubular cooling element by at least one other component. For example, the downstream section may comprise a downstream filter segment between the hollow tubular cooling element and the downstream hollow tubular element.

The downstream hollow tubular element preferably extends to the downstream end of the downstream section. The downstream hollow tubular element therefore preferably extends to the downstream end of the aerosol-generating article. Where the downstream hollow tubular element extends to the downstream end of the aerosol-generating article, the downstream hollow tubular element may define a mouth end cavity of the aerosol-generating article.

In certain embodiments, an additional downstream hollow tubular element may be provided, so that the downstream section comprises two adjacent downstream hollow tubular elements, downstream of the downstream filter segment.

The RTD of the downstream hollow tubular element may be less than or equal to millimeters of water gauge, or less than or equal to 5 millimeters of water gauge, or less than or equal to 2.5 millimeters of water gauge, or less than or equal to 2 millimeters of water gauge. Preferably, the RTD of the downstream hollow tubular element is less than or equal to 1 millimeter of water gauge. The RTD of the downstream hollow tubular element may be at least 0 millimeters of water gauge, or at least 0.25 millimeters of water gauge or at least 0.5 millimeters of water gauge or at least 1 millimeter of water gauge.

The flow channel of the downstream hollow tubular element should therefore be free from any components that would obstruct the flow of air in a longitudinal direction. Preferably, the flow channel is substantially empty and particularly preferably the flow channel is empty.

Preferably, the length of the downstream hollow tubular element is at least 3 millimeters, more preferably at least 4 millimeters, more preferably at least 5 millimeters, more preferably at least 6 millimeters. The length of the downstream hollow tubular element is preferably less than 20 millimeters, more preferably less than 15 millimeters, more preferably less than 12 millimeters and more preferably less than 10 millimeters.

The lumen or cavity of the downstream hollow tubular element may have any cross sectional shape. The lumen of the downstream hollow tubular element may have a circular cross sectional shape.

The downstream hollow tubular element may comprise a paper-based material. The downstream hollow tubular element may comprise at least one layer of paper. The paper may be very rigid paper. The paper may be crimped paper, such as crimped heat resistant paper or crimped parchment paper. The downstream hollow tubular element may comprise cardboard. The downstream hollow tubular element may be a cardboard tube.

The downstream hollow tubular element may be a paper tube. The downstream hollow tubular element may be a tube formed from spirally wound paper. The downstream hollow tubular element may be formed from a plurality of layers of the paper. The paper may have a basis weight of at least 50 grams per square meter, at least 60 grams per square meter, at least 70 grams per square meter, or at least 90 grams per square meter.

The downstream hollow tubular element may comprise a polymeric material. For example, the downstream hollow tubular element may comprise a polymeric film. The polymeric film may comprise a cellulosic film. The downstream hollow tubular element may comprise low density polyethylene (LDPE) or polyhydroxyalkanoate (PHA) fibres. Preferably, the downstream hollow tubular element comprises cellulose acetate tow. For example, in preferred embodiments, the downstream hollow tubular element comprises a hollow acetate tube.

Where the downstream hollow tubular element comprises cellulose acetate tow, the cellulose acetate tow may have a denier per filament of between 2 and 4 and a total denier of between 25 and 40.

Where the downstream section further comprises an additional downstream hollow tubular element, as described above, the additional downstream hollow tubular element may be formed of the same material as the downstream hollow tubular element, or a different material.

In certain preferred embodiments, the downstream section may comprise a ventilation zone at a location on the downstream hollow tubular element. In one example, this ventilation zone at a location on the downstream hollow tubular element may be provided instead of a ventilation zone at a location on the hollow tubular cooling element. In another example, the ventilation zone at a location on the downstream hollow tubular element may be provided in addition to the ventilation zone provided at a location on the hollow tubular cooling element.

The ventilation zone at a location along the downstream hollow tubular element may comprise a plurality of perforations through the peripheral wall of the downstream hollow tubular element. Preferably, the ventilation zone at a location along the downstream hollow tubular element comprises at least one circumferential row of perforations. In some embodiments, the ventilation zone may comprise two circumferential rows of perforations. For example, the perforations may be formed online during manufacturing of the aerosol-generating article. Preferably, each circumferential row of perforations comprises from 8 to 30 perforations.

The aerosol-generating article may comprise one or more hollow tubular elements. The one or more hollow tubular elements may form part of a downstream section of the aerosol-generating article arranged downstream of the aerosol-forming substrate portion. The one or more hollow tubular elements may comprise one or both of a hollow acetate tube (HAT) and a fine hollow acetate tube (FHAT). Such hollow tubes are cylindrical components which may be made from cellulose acetate and which are provided with centrally arranged axial holes. The dimensions of the hollow tubes such as their outer diameter or the diameter of the hole vary and can be designed according to the demands of the respective products.

The HAT may have a length of between 6 millimeters and 10 millimeters, preferably between 7 millimeters and 9 millimeters, more preferably about 8 millimeters. The HAT may be arranged downstream of the aerosol-forming substrate portion, preferably downstream of and directly abutting the aerosol-forming substrate portion. The HAT may serve as on ore more of an airflow-cooling element and an airflow-accelerating element.

The FHAT may be arranged downstream of the HAT, preferably downstream of and directly abutting the HAT. The inner diameter of the FHAT may be larger than the inner diameter of the HAT. For example, the inner diameter of the FHAT may be about twice the size of the inner diameter of the HAT. The FHAT may serve as an airflow-decelerating element.

The aerosol-generating article may comprise a mouth-end filter. The mouth-end filter may be arranged downstream of the aerosol-forming substrate portion. The mouth-end filter may be arranged at a proximal end of the aerosol-generating article. The mouth-end filter may be arranged downstream of and directly abutting the FHAT.

The mouth-end filter may comprise a filter material. The filter material may be a filamentary material, for example cellulose acetate. The dernier per filament may be 12. The dernier of the filter material may be 12Y28.

The length of the mouth-end filter along a longitudinal direction of the aerosol-generating article may be between 10 millimeters and 14 millimeters, preferably between 11 millimeters and 13 millimeters, more preferably about 12 millimeters.

The resistance to draw of the mouth-end filter may be between 1 millimeter of water gauge and 100 millimeters of water gauge, preferably between 2 millimeters of water gauge and 50 millimeters of water gauge, more preferably between 5 millimeters of water gauge and millimeters of water gauge, more preferably between 10 millimeters of water gauge and 30 millimeters of water gauge, more preferably between 16 millimeters of water gauge and 20 millimeters of water gauge, more preferably between 17 millimeters of water gauge and 19 millimeters of water gauge, more preferably is about 18 millimeters of water gauge. The resistance to draw of the mouth-end filter be per millimeter length along a longitudinal direction of the aerosol-generating article may be between 0.1 millimeter of water gauge and 20 millimeters of water gauge, preferably between 0.2 millimeter of water gauge and 10 millimeters of water gauge, more between 0.5 millimeter of water gauge and 5 millimeters of water gauge, more between 1 millimeter of water gauge and 2 millimeters of water gauge, more preferably between 1.3 millimeters of water gauge and 1.7 millimeters of water gauge, more preferably between 1.4 millimeter of water gauge and 1.6 millimeters of water gauge, more preferably about 1.5 millimeters of water gauge.

Aerosol-generating articles according to the present disclosure comprise an upstream section located upstream of the aerosol-forming substrate portion. The upstream section is preferably located immediately upstream of the aerosol-forming substrate portion. The upstream section preferably extends between the upstream end of the aerosol-generating article and the aerosol-forming substrate portion. The upstream section comprises one or more upstream elements located upstream of the aerosol-forming substrate portion.

The aerosol-generating articles of the present invention preferably comprise an upstream element located upstream of and adjacent to the aerosol-forming substrate portion. The upstream element advantageously prevents direct physical contact with the upstream end of the aerosol-forming substrate portion Furthermore, the presence of an upstream element helps to prevent any loss of the substrate, which may be advantageous, for example, if the substrate contains particulate plant material.

Where the upstream segment of the aerosol-forming substrate portion comprises shredded tobacco, such as tobacco cut filler, the upstream section or element thereof may additionally help to prevent the loss of loose particles of tobacco from the upstream end of the article. This may be particularly important when the shredded tobacco has a relatively low density, for example.

An upstream element may be a porous plug element. Preferably, an upstream element has a porosity of at least 50 percent in the longitudinal direction of the aerosol-generating article. More preferably, an upstream element has a porosity of between 50 percent and 90 percent in the longitudinal direction. The porosity of an upstream element in the longitudinal direction is defined by the ratio of the cross-sectional area of material forming the upstream element and the internal cross-sectional area of the aerosol-generating article at the position of the upstream element.

An upstream element may be made of a porous material or may comprise a plurality of openings. This may, for example, be achieved through laser perforation. Preferably, the plurality of openings is distributed homogeneously over the cross-section of the upstream element.

The porosity or permeability of an upstream element may advantageously be designed in order to provide an aerosol-generating article with a particular overall resistance to draw (RTD) without substantially impacting the filtration provided by other portions of the article.

An upstream element may be formed from a material that is impermeable to air. In such embodiments, the aerosol-generating article may be configured such that air flows into the aerosol-forming substrate portion through suitable ventilation means provided in a wrapper.

In certain preferred embodiments of the invention, it may be desirable to minimise the RTD of an upstream element. For example, this may be the case for articles that are intended to be inserted the cavity of an aerosol-generating device such that the aerosol-forming substrate is externally heated, as described herein. For such articles, it is desirable to provide the article with as low an RTD as possible, so that the majority of the RTD experience by the consumer is provided by the aerosol-generating device and not the article.

The RTD of an upstream element may be less than 30 millimeters of water gauge, or less than 20 millimeters of water gauge, or less than 10 millimeters of water gauge, or less than 5 millimeters of water gauge, or less than 2 millimeters of water gauge. The RTD of an upstream element may be at least 0.1 millimeters of water gauge, or at least 0.25 millimeters of water gauge or at least 0.5 millimeters of water gauge. Preferably, an upstream element has an RTD of less than 2 millimeters of water gauge per millimeter of length, more preferably less than 1.5 millimeters of water gauge per millimeter of length, more preferably less than 1 millimeter of water gauge per millimeter of length, more preferably less than 0.5 millimeters of water gauge per millimeter of length, more preferably less than 0.3 millimeters of water gauge per millimeter of length, more preferably less than 0.2 millimeters of water gauge per millimeter of length.

Preferably, the combined RTD of the upstream section, or upstream element thereof, and the aerosol-forming substrate portion is less than 15 millimeters of water gauge, more preferably less than 12 millimeters of water gauge, more preferably less than 10 millimeters of water gauge.

In certain preferred embodiments, an upstream element is formed of a solid cylindrical plug element having a filled cross-section. Such a plug element may be referred to as a ‘plain’ element. The solid plug element may be porous, as described above, but does not have a tubular form and therefore does not provide a longitudinal flow channel. The solid plug element preferably has a substantially uniform transverse cross section.

In other preferred embodiments, an upstream element is formed of a hollow tubular segment defining a longitudinal cavity providing an unrestricted flow channel. In such embodiments, an upstream element can provide protection for the aerosol-forming substrate, as described above, whilst having a minimal effect on the overall resistance to draw (RTD) and filtration properties of the article.

Preferably, the diameter of the longitudinal cavity of the hollow tubular segment forming an upstream element is at least 3 millimeters, more preferably at least 3.5 millimeters, more preferably at least 4 millimeters and more preferably at least 4.5 millimeters. Preferably, the diameter of the longitudinal cavity is maximised in order to minimise the RTD of the upstream section, or upstream element thereof.

Preferably, the wall thickness of the hollow tubular segment is less than 2 millimeters, more preferably less than 1.5 millimeters and more preferably less than 1 millimeter.

An upstream element of the upstream section may be made of any material suitable for use in an aerosol-generating article. The upstream element may, for example, be made of a same material as used for one of the other components of the aerosol-generating article, such as the downstream filter segment or the hollow tubular cooling element. Suitable materials for forming the upstream element include filter materials, ceramic, polymer material, cellulose acetate, cardboard, zeolite or aerosol-forming substrate. The upstream element may comprise a plug of cellulose acetate. The upstream element may comprise a hollow acetate tube, or a cardboard tube.

Preferably, an upstream element is formed of a heat resistant material. For example, preferably an upstream element is formed of a material that resists temperatures of up to 350 degrees Celsius. This ensures that an upstream element is not adversely affected by the heating means for heating the aerosol-forming substrate.

Preferably, the upstream section, or an upstream element thereof, has an external diameter that is approximately equal to the external diameter of the aerosol-generating article. Preferably, the external diameter of the upstream section, or an upstream element thereof, is between 5 millimeters and 8 millimeters, more preferably between 5.25 millimeters and 7.5 millimeters, more preferably between 5.5 millimeters and 7 millimeters.

Preferably, the upstream section or an upstream element has a length of between 2 millimeters and 10 millimeters, more preferably between 3 millimeters and 8 millimeters, more preferably between 2 millimeters and 6 millimeters. In a particularly preferred embodiment, the upstream section or an upstream element has a length of 5 millimeters.

The upstream section is preferably circumscribed by a component wrapper, such as a plug wrap. The component wrapper circumscribing the upstream section is preferably a stiff plug wrap, for example, a plug wrap having a basis weight of at least 80 grams per square meter, or at least 100 grams per square meter, or at least 110 grams per square meter. This provides structural rigidity to the upstream section.

The upstream section is preferably connected to the aerosol-forming substrate portion and optionally at least a part of the downstream section by means of an outer wrapper.

The aerosol-generating article may comprise an upstream section comprising a front plug. The front plug may be arranged upstream of and directly abutting the aerosol-forming substrate portion. The front plug may be arranged at a distal end of the aerosol-generating article. The front plug may comprise a filter material. The length of the front plug along a longitudinal direction of the aerosol-generating article may be between 1 millimeter and 10 millimeters, preferably between 3 millimeters and 7 millimeters, more preferably between 4 millimeters and 6 millimeters, more preferably about 5 millimeters. The front plug may be in the form of a full cylinder.

The resistance to draw of the front plug may be between 1 millimeter of water gauge and 150 millimeters of water gauge, preferably between 1 millimeter of water gauge and 50 millimeters of water gauge, more preferably between 1 millimeter of water gauge and millimeters of water gauge, more preferably between 1 millimeter of water gauge and millimeters of water gauge. The resistance to draw of the front plug may be about millimeters of water gauge or less.

The front plug may assist in maintaining cleanliness of the aerosol-generating device by trapping slurry in the consumable. The front plug may hinder aerosol-forming substrate or a heating element from falling out of the aerosol-generating article.

The aerosol-generating article in accordance with the invention may have an overall length of at least 40 millimeters, or at least 50 millimeters, or at least 60 millimeters.

An overall length of an aerosol-generating article in accordance with the invention may be less than or equal to 90 millimeters, or less than or equal to 85 millimeters, or less than or equal to 80 millimeters.

In some embodiments, an overall length of the aerosol-generating article is preferably from 50 millimeters to 90 millimeters, more preferably from 60 millimeters to 90 millimeters, even more preferably from 70 millimeters to 90 millimeters. In other embodiments, an overall length of the aerosol-generating article is preferably from 50 millimeters to 85 millimeters, more preferably from 60 millimeters to 85 millimeters, even more preferably from 70 millimeters to 85 millimeters. In further embodiments, an overall length of the aerosol-generating article is preferably from 50 millimeters to 80 millimeters, more preferably from 60 millimeters to 80 millimeters, even more preferably from 70 millimeters to 80 millimeters. In an exemplary embodiment, an overall length of the aerosol-generating article is 75 millimeters.

In some embodiments, an overall length of the aerosol-generating article is preferably from 40 millimeters to 70 millimeters, more preferably from 45 millimeters to 70 millimeters. In other embodiments, an overall length of the aerosol-generating article is preferably from 40 millimeters to 60 millimeters, more preferably from about 45 millimeters to about 60 millimeters. In further embodiments, an overall length of the aerosol-generating article is preferably from millimeters to 50 millimeters, more preferably from 45 millimeters to 50 millimeters. In an exemplary embodiment, an overall length of the aerosol-generating article is about 45 millimeters.

Preferably, the aerosol-generating article has an external diameter of at least about 5 millimeters. More preferably, the aerosol-generating article has an external diameter of at least 5.25 millimeters. Even more preferably, the aerosol-generating article has an external diameter of at least 5.5 millimeters.

The aerosol-generating article preferably has an external diameter of less than or equal to 8 millimeters. More preferably, the aerosol-generating article has an external diameter of less than or equal to 7.5 millimeters. Even more preferably, the aerosol-generating article has an external diameter of less than or equal to 7 millimeters.

The aerosol-generating article may have an external diameter of between 5 millimeters and 8 millimeters, or between 5 millimeters and 7.5 millimeters, or between 5 millimeters and 7 millimeters, or between 5.25 millimeters and 8 millimeters, or between 5.25 millimeters and 7.5 millimeters, or between 5.25 millimeters and 7 millimeters, or between 5.5 millimeters and 8 millimeters, or between 5.5 millimeters and 7.5 millimeters, or between 5.5 millimeters and 7 millimeters.

The external diameter of the aerosol-generating article may be substantially constant over the whole length of the article. As an alternative, different portions of the aerosol-generating article may have different external diameters.

Preferably, the overall RTD of the aerosol-generating article is at least 10 millimeters of water gauge. For example, the overall RTD of the aerosol-generating article may be at least millimeters of water gauge, at least 30 millimeters of water gauge, at least 35 millimeters of water gauge, or at least 40 millimeters of water gauge.

The overall RTD of the aerosol-generating article may be no more than 70 millimeters of water gauge. For example, the overall RTD of the aerosol-generating article may be no more than 65 millimeters of water gauge, no more than 60 millimeters of water gauge, or no more than 55 millimeters of water gauge, or no more than 50 millimeters.

The overall RTD of the aerosol-generating article may be between 10 millimeters of water gauge and 70 millimeters of water gauge. For example, the overall RTD of the aerosol-generating article may be between 20 millimeters of water gauge and 65 millimeters of water gauge, between 30 millimeters of water gauge and 60 millimeters of water gauge, between 35 millimeters of water gauge and 55 millimeters of water gauge, or between 40 millimeters of water gauge and 50 millimeters of water gauge.

The aerosol-generating article may comprise ventilation holes. The ventilation holes may promote nucleation of the aerosol. The ventilation holes may assist in cooling the airflow. The ventilation holes may be provided in the FHAT. The FHAT may comprise 11 ventilation holes each having a diameter of 0.11 millimeter.

The total resistance to draw of the aerosol-generating article may be between millimeters of water gauge and 200 millimeters of water gauge, preferably between millimeters of water gauge and 150 millimeters of water gauge, more preferably between millimeters of water gauge and 100 millimeters of water gauge, more preferably between 80 millimeters of water gauge and 80 millimeters of water gauge, more preferably between 40 millimeters of water gauge and 60 millimeters of water gauge, more preferably between 45 millimeters of water gauge and 55 millimeters of water gauge, more preferably about 48 millimeters of water gauge.

The aerosol-generating article may have a cylindrical shape. The aerosol-forming substrate portion may have a cylindrical shape.

The aerosol-generating article may comprise, in order from a proximal end to a distal end of the article, a mouth-end filter, one or more intermediate elements, an aerosol-forming substrate portion, and, optionally, a front plug. The one or more intermediate elements may comprise one or more of a HAT, a FHAT, and a PLA plug. The total length of the article may be about 45 millimeters and the length of the length of the aerosol-forming substrate portion may be about 11 millimeters. The wrapper may circumscribe the complete article or only a portion thereof.

The invention further relates to a package comprising a plurality of aerosol-generating articles, wherein each aerosol-generating article in the package is an aerosol-generating article as described herein.

The invention further relates to an aerosol-generating system comprising the aerosol-generating article as described herein and an aerosol-generating device. The aerosol-generating device may comprise a cavity configured for at least partly inserting the aerosol-generating article into the cavity. The cavity may be a heating chamber. The aerosol-generating device may comprise an internal heating element arranged for being inserted into the aerosol-generating article, when the aerosol-generating article is at least partly inserted into the heating chamber. The aerosol-generating device may comprise an inductor coil. The inductor coil may at least partly circumscribe the heating chamber. The inductor coil may be arranged to coaxially circumscribe the heating chamber. The inductor coil may be arranged to inductively heat a susceptor element. The susceptor element may be part of an internal heating element of the aerosol-generating device. The susceptor element may be part of the aerosol-generating article. The inductor coil may be arranged to inductively heat a susceptor of the aerosol-generating article when the aerosol-generating article is at least partly inserted into the heating chamber.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “tubular element” is used to denote an elongate element defining a lumen or airflow passage along a longitudinal axis thereof. In particular, the term “tubular” is used herein to encompass any tubular element having a substantially cylindrical cross-section and defining at least one airflow passage establishing an uninterrupted fluid communication between an upstream end of the tubular element and a downstream end of the tubular element. However, it will be understood that alternative geometries of the tubular element may be possible.

As used herein, the terms “upstream” and “front”, and “downstream” and “rear”, are used to describe the relative positions of components, or portions of components, of the aerosol generating article in relation to the direction in which airflows through the aerosol generating article during use thereof. Aerosol generating articles according to the invention comprise a proximal end through which, in use, an aerosol exits the article. The proximal end of the aerosol generating article may also be referred to as the mouth end or the downstream end. The mouth end is downstream of the distal end. The distal end of the aerosol generating article may also be referred to as the upstream end. Components, or portions of components, of the aerosol generating article may be described as being upstream or downstream of one another based on their relative positions between the proximal end of the aerosol generating article and the distal end of the aerosol generating article. The front of a component, or portion of a component, of the aerosol generating article is the portion at the end closest to the upstream end of the aerosol generating article. The rear of a component, or portion of a component, of the aerosol generating article is the portion at the end closest to the downstream end of the aerosol generating article.

As used herein, the term “longitudinal” refers to the direction corresponding to the main longitudinal axis of the aerosol-generating article, which extends between the upstream and downstream ends of the aerosol-generating article.

The term “length” denotes the dimension of a component of the aerosol-generating article in the longitudinal direction. For example, it may be used to denote the dimension of the rod or of the elongate tubular elements in the longitudinal direction.

As used herein with reference to the present invention, the term “transverse” is used to describe the direction perpendicular to the longitudinal direction. Unless otherwise stated, references to the “cross-section” of the aerosol-generating article or a component of the aerosol-generating article refer to the transverse cross-section.

As used herein, the term “proximal” refers to a user-end, or mouth-end of the aerosol-generating article, and the term “distal” refers to the end opposite to the proximal end.

Components of aerosol-generating articles according to the present invention may be described as being upstream or downstream of one another based on their relative positions between the proximal end of the aerosol-generating article and the distal end of the aerosol-generating article.

The aerosol-generating device suitable for use with an aerosol-generating article as described herein may comprise a cavity for receiving at least part of the aerosol-generating article and a heater for heating the aerosol-forming substrate portion of the aerosol-generating article when the aerosol-generating article is received within the cavity. The cavity may be a heating chamber.

At least 25 percent of the length of the downstream section may be inserted or received within the device cavity, when the aerosol-generating article is received within the device. At least 30 percent of the length of the downstream section may be inserted or received within the device cavity, when the aerosol-generating article is received within the device.

The aerosol-generating device may comprise a heater for heating the aerosol-generating article. The heater may be any suitable type of heater. Preferably, in the present invention, the heater is an external heater. Preferably, the heater externally heats the aerosol-forming substrate portion when the aerosol-generating article is received within the aerosol-generating device. Such an external heater may circumscribe the aerosol-generating article when inserted in or received within the aerosol-generating device.

In some embodiments, the heater is arranged for insertion into an aerosol-forming substrate when the aerosol-forming substrate is received within the cavity.

The heater may be positioned within the device cavity, or heating chamber.

The heater may comprise at least one heating element. The at least one heating element may be any suitable type of heating element. In some embodiments, the device comprises only one heating element. In some embodiments, the device comprises a plurality of heating elements.

The heater may comprise a resistive heating arrangement.

In some embodiments, the heater comprises an inductive heating arrangement. The inductive heating arrangement may comprise an inductor coil and a power supply configured to provide high frequency oscillating current to the inductor coil. As used herein, a high frequency oscillating current means an oscillating current having a frequency of between about 500 KHz and about 30 MHz. The heater may advantageously comprise a DC/AC inverter for converting a DC current supplied by a DC power supply to the alternating current. The inductor coil may be arranged to generate a high frequency oscillating electromagnetic field on receiving a high frequency oscillating current from the power supply. The inductor coil may be arranged to generate a high frequency oscillating electromagnetic field in the device cavity. In some embodiments, the inductor coil may substantially circumscribe the device cavity. The inductor coil may extend at least partially along the length of the device cavity.

The heater may comprise an inductive heating element. The inductive heating element may be a susceptor element. A susceptor element may be arranged such that, when the aerosol-generating article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per meter (kA m), preferably between 2 and 3 kA/m, for example about 2.5 kA/m. The electrically-operated aerosol-generating device is preferably capable of generating a fluctuating electromagnetic field having a frequency of between 1 and 30 MHz, for example between 1 and 10 MHz, for example between 5 and 7 MHz.

In these embodiments, the susceptor element is preferably located in contact with the aerosol-forming substrate. In some embodiments, a susceptor element is located in the aerosol-generating device. In these embodiments, the susceptor element may be located in the cavity. The aerosol-generating device may comprise only one susceptor element. The aerosol-generating device may comprise a plurality of susceptor elements. In some embodiments, the susceptor element is preferably arranged to heat the outer surface of the aerosol-forming substrate.

The susceptor element may be part of the aerosol-generating device. The susceptor element may be part of the aerosol-generating article.

The susceptor element of the device may comprise any suitable material, as described above in relation to a susceptor element incorporated within the aerosol-forming substrate portion.

During use, the heater may be controlled to operate within a defined operating temperature range, below a maximum operating temperature. An operating temperature range between about 150 degrees Celsius and about 300 degrees Celsius in the heating chamber (or device cavity) is preferable. The operating temperature range of the heater may be between about 150 degrees Celsius and about 250 degrees Celsius.

The aerosol-generating device may comprise a power supply. The power supply may be a DC power supply. In some embodiments, the power supply is a battery. The power supply may be a nickel-metal hydride battery, a nickel cadmium battery, or a lithium based battery, for example a lithium-cobalt, a lithium-iron-phosphate or a lithium-polymer battery. However, in some embodiments the power supply may be another form of charge storage device, such as a capacitor. The power supply may require recharging and may have a capacity that allows for the storage of enough energy for one or more user operations, for example one or more aerosol-generating experiences.

Below, there is provided a non-exhaustive list of non-limiting examples. Any one or more of the features of these examples may be combined with any one or more features of another example, embodiment, or aspect described herein.

Example E1: An aerosol-generating article, comprising
an aerosol-forming substrate having a pH value of below 5 and comprising an aerosol former content of at least 5 percent by weight on a dry weight basis; and
a wrapper at least partly circumscribing the aerosol-forming substrate,
wherein the wrapper has a content of calcium carbonate of less than 45 percent by weight.

Example E2: The aerosol-generating article according to Example E1, wherein the aerosol-forming substrate comprises a total aerosol former content on a dry weight basis of at least 10 percent by weight, preferably at least 15 percent by weight, more preferably at least percent by weight, more preferably at least 25 percent by weight, more preferably at least percent by weight, more preferably at least 35 percent by weight, more preferably at least percent by weight, more preferably at least 45 percent by weight, more preferably at least 50 percent by weight, more preferably at least 55 percent by weight.

Example E3: The aerosol-generating article according to Example E1 or Example E2, wherein the aerosol-forming substrate comprises nicotine, one or more cellulose based agents, one or more aerosol formers, and one or more carboxylic acids.

Example E4: The aerosol-generating article according to any of the preceding examples, wherein the aerosol-forming substrate comprises between 0.1 percent by weight and 8 percent by weight, preferably between 0.1 percent by weight and 6 percent by weight, more preferably between 0.5 percent by weight and 4 percent by weight, more preferably between 1.5 percent by weight and 4 percent by weight, more preferably between 2 percent by weight and 4 percent by weight of one or more carboxylic acids on a dry weight basis.

Example E5: The aerosol-generating article according to any of the preceding examples, wherein the aerosol-forming substrate comprises one or more carboxylic acids that do not contain any non-carboxyl hydroxyl groups.

Example E6: The aerosol-generating article according to any of the preceding examples, wherein the aerosol-forming substrate comprises nicotine and one or more carboxylic acids, and wherein a molar ratio of total carboxylic acid to nicotine is between 0.5:1 and 5:1, preferable between 1:1 and 4:1, more preferably between 2:1 and 3.5:1, more preferably between 0 and 0.3, more preferably between 0 and 0.2, more preferably between 0 and 0.1.

Example E7: The aerosol-generating article according to any of the preceding examples, wherein the aerosol-forming substrate comprises one or more carboxylic acids, and wherein the one or more carboxylic acids is selected from fumaric acid, maleic acid, and malic acid, preferably wherein the one or more carboxylic acids is selected from fumaric acid and maleic acid, more preferably wherein the one or more carboxylic acids is fumaric acid.

Example E8: The aerosol-generating article according to any of the preceding examples, wherein the aerosol-forming substrate comprises between 0.5 percent by weight and 5 percent by weight, preferably between 0.5 percent by weight and 3 percent by weight, more preferably between 1 percent by weight and 2 percent by weight of fumaric acid on a dry weight basis.

Example E9: The aerosol-generating article according to any of the preceding examples, wherein the aerosol-forming substrate comprises between 0.5 percent by weight and 5 percent by weight, preferably between 0.5 percent by weight and 3 percent by weight, more preferably between 1 percent by weight and 2 percent by weight of maleic acid on a dry weight basis.

Example E10: The aerosol-generating article according to any of the preceding examples, wherein the aerosol-forming substrate comprises one or both of fumaric acid and maleic acid, and wherein the sum of fumaric acid and maleic acid comprised in the aerosol-forming substrate is between 0.5 percent by weight and 5 percent by weight, preferably between 0.5 percent by weight and 3 percent by weight, more preferably between 1 percent by weight and 2 percent by weight on a dry weight basis.

Example E11: The aerosol-generating article according to any of the preceding examples, wherein the aerosol-forming substrate comprises less than 6 percent by weight, preferably less that 4 percent by weight, more preferably less than 2 percent by weight, more preferably less than 1 percent by weight of malic acid on a dry weight basis.

Example E12: The aerosol-generating article according to any of the preceding examples, wherein the aerosol-forming substrate comprises one or more carboxylic acids selected from acetic acid, benzoic acid, lactic acid, and levulinic acid, or wherein the aerosol-forming substrate does not comprise a carboxylic acid selected from acetic acid, benzoic acid, lactic acid, and levulinic acid.

Example E13: The aerosol-generating article according to any of the preceding examples, wherein the aerosol-forming substrate has a total cellulose based agent content of between 35 percent by weight and 50 percent by weight.

Example E14: The aerosol-generating article according to any of the preceding examples, wherein the aerosol-forming substrate comprises one or more cellulose based film-forming agents selected from carboxymethyl cellulose and hydroxypropyl methylcellulose.

Example E15: The aerosol-generating article according to any of the preceding examples, wherein the aerosol-forming substrate comprises one or more cellulose based strengthening agents selected from cellulose fibres, microcrystalline cellulose and cellulose powder.

Example E16: The aerosol-generating article according to any of the preceding examples, wherein the aerosol-forming substrate is a solid aerosol-forming film, preferably wherein the solid aerosol-forming film remains solid when heated to a temperature of between 180 degrees Celsius and 350 degrees Celsius.

Example E17: The aerosol-generating article according to any of the preceding examples, wherein the aerosol-forming substrate is provided in form of a film or gel.

Example E18: The aerosol-generating article according to Example E17, wherein the aerosol-forming substrate is provided in form of a film having a thickness of from about 0.1 millimeter to about 1 millimeter, preferably from about 0.05 millimeter to about 0.75 millimeter, more preferably from about 0.05 millimeter to about 0.5 millimeter, more preferably from 50 micrometers to 400 micrometers, more preferably from 100 micrometers to 200 micrometers.

Example E19: The aerosol-generating article according to any of the preceding examples, wherein the total mass of aerosol-forming substrate in the aerosol-generating article is between 200 milligrams and 400 milligrams, preferably between 240 milligrams and 340 milligrams, more preferably between 250 milligrams and 290 milligrams, more preferably between 260 milligrams and 280 milligrams.

Example E20: The aerosol-generating article according to any of the preceding examples, wherein the aerosol-forming substrate is tobacco-free.

Example E21: The aerosol-generating article according to any of the preceding examples, wherein the wrapper has a content of calcium carbonate of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight, more preferably does not comprise calcium carbonate.

Example E22: The aerosol-generating article according to any of the preceding examples, wherein the a sum of the content of calcium carbonate and magnesium carbonate in the wrapper is less than 40 percent by weight, preferably less than 35 percent by weight, more preferably less than 30 percent by weight, more preferably less than 25 percent by weight, more preferably less than 20 percent by weight, more preferably less than 15 percent by weight, more preferably less than 10 percent by weight, more preferably less than 5 percent by weight, more preferably less than 4 percent by weight, more preferably less than 3 percent by weight, more preferably less than 2 percent by weight, more preferably less than 1 percent by weight, more preferably wherein the wrapper does not comprise any of calcium carbonate and magnesium carbonate.

Example E23: The aerosol-generating article according to any of the preceding examples, wherein the wrapper has a content of alkaline metal carbonates of less than 40 percent by weight, preferably of less than 35 percent by weight, more preferably of less than percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight, more preferably does not comprise metal carbonates.

Example E24: The aerosol-generating article according to Example E23, wherein the wrapper has a content of metal carbonates of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight, more preferably does not comprise metal carbonates.

Example E25: The aerosol-generating article according to any of the preceding examples,
wherein the wrapper has a total content of filler materials selected from one or more of China clay, calcium carbonate, talc, titanium dioxide, starch, calcium sulfate, Gypsum (calcium sulfate dihydrate), barium sulfate, magnesium carbonate, Bentonite, aluminium hydroxide (hydrated alumina), silicate minerals like silica or silicate pigments, and zinc pigments of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight, more preferably
wherein the wrapper does not comprise any filler materials selected from China clay, calcium carbonate, talc, titanium dioxide, starch, calcium sulfate, Gypsum (calcium sulfate dihydrate), barium sulfate, magnesium carbonate, Bentonite, aluminium hydroxide (hydrated alumina), silicate minerals like silica or silicate pigments, and zinc pigments.

Example E26: The aerosol-generating article according to Example E25, wherein the wrapper has a total content of filler materials of less than 40 percent by weight, preferably of less than 35 percent by weight, more preferably of less than 30 percent by weight, more preferably of less than 25 percent by weight, more preferably of less than 20 percent by weight, more preferably of less than 15 percent by weight, more preferably of less than 10 percent by weight, more preferably of less than 5 percent by weight, more preferably of less than 4 percent by weight, more preferably of less than 3 percent by weight, more preferably of less than 2 percent by weight, more preferably of less than 1 percent by weight, more preferably does not comprise any filler materials.

Example E27: The aerosol-generating article according to any of the preceding examples, wherein a ratio of weight percentages of calcium carbonate to other fillers comprised in the wrapper is between 0 and 10, preferable between 0 and 1, more preferably between 0 and 0.5, more preferably between 0 and 0.3, more preferably between 0 and 0.2, more preferably between 0 and 0.1.

Example E28: The aerosol-generating article according to any of the preceding examples, wherein a ratio of calcium carbonate to titanium dioxide comprised in the wrapper is between 0 and 10, preferable between 0 and 1, more preferably between 0 and 0.5, more preferably between 0 and 0.3, more preferably between 0 and 0.2, more preferably between 0 and 0.1.

Example E29: The aerosol-generating article according to any of the preceding examples, wherein the wrapper comprises one or more fillers other than calcium carbonate, and wherein the sum of the weight percentage of the one or more fillers other than calcium carbonate in the wrapper is at least equal to the weight percentage of calcium carbonate in the wrapper.

Example E30: The aerosol-generating article according to any of the preceding examples, wherein the wrapper comprises titanium dioxide, and wherein the weight percentage of titanium dioxide in the wrapper is at least equal to the weight percentage of calcium carbonate in the wrapper.

Example E31: The aerosol-generating article according to any of the preceding examples, wherein the wrapper comprises at least 5 percent by weight, preferably at least 10 percent by weight, more preferably at least 15 percent by weight, more preferably at least 20 percent by weight, more preferably at least 25 percent by weight, more preferably at least 30 percent by weight, more preferably at least 35 percent by weight, more preferably at least 40 percent by weight of titanium dioxide.

Example E32: The aerosol-generating article according to any of the preceding examples, wherein the wrapper has a pH value of below 7.8, or wherein the wrapper has a pH value of more than 8.

Example E33: The aerosol-generating article according to any of the preceding examples, wherein the wrapper forms the outermost layer of the aerosol-generating article.

Example E34: The aerosol-generating article according to any of the preceding examples, wherein there is no intermediate material layer between the wrapper and the aerosol-forming substrate.

Example E35: The aerosol-generating article according to Example E34, wherein the wrapper is in direct physical contact with the aerosol-forming substrate.

Example E36: The aerosol-generating article according to any of the preceding examples, wherein the grammage of the wrapper is between 30 grams per square meter and 100 grams per square meter, preferably between 50 grams per square meter and 90 grams per square meter, more preferably between 60 grams per square meter and 80 grams per square meter.

Example E37: The aerosol-generating article according to any of the preceding examples, wherein the thickness of the wrapper is between 50 micrometers and 90 micrometers, preferably between 60 micrometers and 80 micrometers, more preferably between 65 micrometers and 75 micrometers.

Example E38: The aerosol-generating article according to any of the preceding examples, wherein the grammage of the wrapper is between 55 grams per square meter and 65 grams per square meter and the thickness of the wrapper is between 65 micrometers and 75 micrometers and wherein the wrapper does not comprise any filler.

Example E39: An aerosol-generating article, comprising
an aerosol-forming substrate comprising one or more acids, preferably organic acids, more preferably organic carboxylic acids; and
a wrapper at least partly circumscribing the aerosol-forming substrate,
wherein the wrapper has a content of calcium carbonate of less than 45 percent by weight.

Example E40: An aerosol-generating article, comprising
an aerosol-forming substrate comprising one or more acids selected from fumaric acid, maleic acid, malic acid, acetic acid, benzoic acid, lactic acid, and levulinic acid; and
a wrapper at least partly circumscribing the aerosol-forming substrate,
wherein the wrapper has a content of calcium carbonate of less than 45 percent by weight.

Example E41: An aerosol-generating article, comprising
an acidic aerosol-forming substrate having a pH value of less than 7; and
a wrapper at least partly circumscribing the aerosol-forming substrate,
wherein the wrapper comprises an alkaline paper having a pH value of above 7 and having a content of calcium carbonate of less than 45 percent by weight.

Example E42: An aerosol-generating article, comprising
an aerosol-forming substrate comprising nicotine, one or more cellulose based agents, one or more aerosol formers, and one or more carboxylic acids; and
a wrapper at least partly circumscribing the aerosol-forming substrate,
wherein the wrapper has a content of calcium carbonate of less than 45 percent by weight.

Example E43: An aerosol-generating article, comprising
an aerosol-forming substrate provided in form of a film or gel; and
a wrapper at least partly circumscribing the aerosol-forming substrate,
wherein the wrapper has a content of calcium carbonate of less than 45 percent by weight.

Example E44: An aerosol-generating article, comprising
an aerosol-forming substrate comprising an aerosol former content of at least 5 percent by weight on a dry weight basis, an acid content of at least 1 percent by weight on a dry weight basis, and a tobacco content on a dry weight basis of less than 75 percent by weight, preferably less than 70 percent by weight, more preferably less than 65 percent by weight, more preferably less than 60 percent by weight, more preferably less than 55 percent by weight, more preferably less than 50 percent by weight, more preferably less than 45 percent by weight, more preferably less than 40 percent by weight, more preferably less than 35 percent by weight, more preferably less than 30 percent by weight, more preferably less than 25 percent by weight, more preferably less than 20 percent by weight, more preferably less than percent by weight, more preferably less than 10 percent by weight, more preferably less than 5 percent by weight, more preferably less than 4 percent by weight, more preferably less than 3 percent by weight, more preferably less than 2 percent by weight, more preferably less than 1 percent by weight; and
a wrapper at least partly circumscribing the aerosol-forming substrate,
wherein the wrapper has a content of calcium carbonate of less than 45 percent by weight.

Example E45: An aerosol-generating system comprising the aerosol-generating article according to any of the preceding examples and an aerosol-generating device comprising a cavity configured for at least partly inserting the aerosol-generating article into the cavity, preferably, wherein the cavity is a heating chamber.

Features described in relation to one embodiment may equally be applied to other embodiments of the invention.

The invention will be further described, by way of example only, with reference to the accompanying drawings in which:

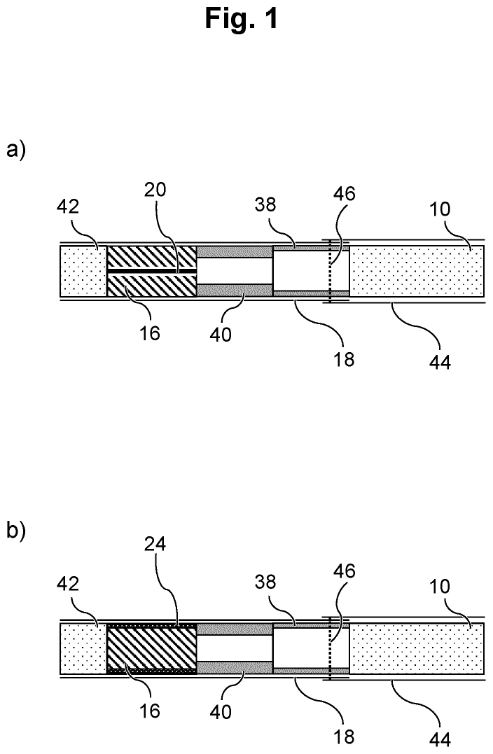

FIGS. 1a and 1b show aerosol-generating articles.

FIG. 1a shows an aerosol-generating article in a cross-sectional view. The article of FIG. 1a comprises a mouth-end filter 10, a fine hollow acetate tube 38, a hollow acetate tube 40, an aerosol-forming substrate portion 16 comprising aerosol-forming substrate, and a front plug 42. The aerosol-forming substrate has a pH value of below 5 and comprises an aerosol former content of at least 5 percent by weight on a dry weight basis. The aerosol-forming substrate may be an aerosol-forming substrate as described herein. The mouth-end filter 10, the fine hollow acetate tube 38, and the hollow acetate tube 40 form a downstream section downstream of the aerosol-forming substrate portion 16. The front plug 42 forms an upstream section upstream of the aerosol-forming substrate portion 16.

The aerosol-forming substrate may comprise between 0.1 percent by weight and 8 percent by weight, more preferably between 0.1 percent by weight and 6 percent by weight, more preferably between 0.5 percent by weight and 5 percent by weight, more preferably between 1.5 percent by weight and 4 percent by weight, more preferably between 2 percent by weight and 4 percent by weight of one or more carboxylic acids on a dry weight basis.

Preferably, the one or more carboxylic acids is fumaric acid. The aerosol-forming substrate may have an aerosol former content of at least 35 percent by weight on a dry weight basis. The aerosol-forming substrate may have glycerine content of at least 35 percent by weight on a dry weight basis. The aerosol-forming substrate may comprise a tobacco content on a dry weight basis of less than 75 percent by weight, preferably less than 70 percent by weight, more preferably less than 65 percent by weight, more preferably less than 60 percent by weight, more preferably less than 55 percent by weight, more preferably less than 50 percent by weight, more preferably less than 45 percent by weight, more preferably less than 40 percent by weight, more preferably less than 35 percent by weight.

Preferably, the aerosol-forming substrate comprises, on a dry weight basis, an aerosol former content of at least 35 percent by weight, a tobacco content of less than 35 percent by weight, and between 0.5 percent by weight and 4 percent by weight of one or more carboxylic acids. More preferably, the aerosol-forming substrate comprises, on a dry weight basis, a glycerine content of at least 35 percent by weight, a tobacco content of less than 35 percent by weight, and between 0.5 percent by weight and 4 percent by weight of one or more carboxylic acids. More preferably, the aerosol-forming substrate comprises, on a dry weight basis, a glycerine content of at least 35 percent by weight, a tobacco content of less than 35 percent by weight, and between 0.5 percent by weight and 4 percent by weight of fumaric acid.

The aerosol-forming substrate may be provided in form of a film or gel.

The aerosol-forming substrate portion 16 may comprise an optional susceptor 20. The front plug 42 may be a filter plug. A distal portion of the article including the aerosol-forming substrate portion 16 is circumscribed by a tipping wrapper 18 and a proximal portion is circumscribed by a mouthpiece wrapper 44. The tipping wrapper has a content of calcium carbonate of less than 45 percent by weight.

A circumferential row of ventilation holes 46 is provided in an area where the mouthpiece wrapper 44 overlaps the tipping wrapper 18. The ventilation holes 46 may be provided in one or both of the fine hollow acetate tube 38, the mouthpiece wrapper 44, and the tipping wrapper 18.

An outer diameter of the article may be about 7 millimeters, preferably 7.1 millimeters. A total length of the article may be about 45 millimeters. In one embodiment, a length of the mouth-end filter 10 is about 12 millimeters, a length of the fine hollow acetate tube 38 is about 9 millimeters, a length of the hollow acetate tube 40 is about 8 millimeters, a length of the aerosol-forming substrate portion 16 is about 11 millimeters, and a length of the front plug 42 is about 5 millimeters.

FIG. 1b shows an aerosol-generating article in a cross-sectional view. The article of FIG. 1b differs from the article of FIG. 1a in that the article of FIG. 1b comprises an additional substrate wrapper 24 circumscribing the aerosol-forming substrate portion 16. Further, the optional susceptor 20 is absent in the embodiment of FIG. 1b.

The substrate wrapper 24 may have a content of calcium carbonate of less than 45 percent by weight. In embodiments where the substrate wrapper 24 has a content of calcium carbonate of less than 45 percent by weight, the tipping wrapper 18 may also have a content of calcium carbonate of less than 45 percent by weight, or may have any content of calcium carbonate.

1.-15. (canceled)

16. An aerosol-generating article, comprising:
an aerosol-forming substrate having a pH value of below 5 and comprising an aerosol former content of at least 5 percent by weight on a dry weight basis; and
a wrapper at least partly circumscribing the aerosol-forming substrate,
wherein the wrapper has a content of calcium carbonate of less than 45 percent by weight.

17. The aerosol-generating article according to claim 16, wherein the aerosol-forming substrate further comprises a total aerosol former content on a dry weight basis of at least 30 percent by weight.

18. The aerosol-generating article according to claim 16, wherein the aerosol-forming substrate further comprises between 0.1 percent by weight and 8 percent by weight of one or more carboxylic acids on a dry weight basis.

19. The aerosol-generating article according to claim 16, wherein the aerosol-forming substrate further comprises one or more carboxylic acids selected from fumaric acid, maleic acid, and malic acid.

20. The aerosol-generating article according to claim 16, wherein the aerosol-forming substrate is provided in a form of a film or gel.

21. The aerosol-generating article according to claim 16, wherein the aerosol-forming substrate further comprises a tobacco content on a dry weight basis of less than 5 percent by weight.

22. The aerosol-generating article according to claim 16, wherein the wrapper has a content of calcium carbonate of less than 15 percent by weight.

23. The aerosol-generating article according to claim 16, wherein the wrapper has a total content of filler materials of less than 40 percent by weight.

24. The aerosol-generating article according to claim 16, wherein a ratio of calcium carbonate to titanium dioxide comprised in the wrapper is between 0 and 10.

25. The aerosol-generating article according to claim 16,
wherein the wrapper comprises one or more fillers other than calcium carbonate, and
wherein a sum of the weight percentage of the one or more fillers other than calcium carbonate in the wrapper is at least equal to a weight percentage of calcium carbonate in the wrapper.

26. The aerosol-generating article according to claim 16,
wherein the wrapper comprises titanium dioxide, and
wherein a weight percentage of titanium dioxide in the wrapper is at least equal to a weight percentage of calcium carbonate in the wrapper.

27. The aerosol-generating article according to claim 16, wherein the wrapper comprises at least 5 percent by weight of titanium dioxide.

28. The aerosol-generating article according to claim 16,
wherein the wrapper has a pH value of below 7.8, or
wherein the wrapper has a pH value of more than 8.

29. The aerosol-generating article according to claim 16, wherein the wrapper forms an outermost layer of the aerosol-generating article at a longitudinal position where the wrapper circumscribes the aerosol-forming substrate.

30. An aerosol-generating system comprising the aerosol-generating article according to claim 16 and an aerosol-generating device comprising a cavity configured for at least partly inserting the aerosol-generating article into the cavity.

31. The aerosol-generating system according to claim 30, wherein the cavity is a heating chamber.
